(19) United States
(12) Patent Application Publication
(10) Pub. No.: US 2021/0398238 A1
(43) Pub. Date: Dec. 23, 2021

(54) Systems and Methods for Destination Shipment Consolidation

(71) Applicant: The Eighth Notch Inc., Alamo, CA (US)

(72) Inventor: Jamison Sapp, Alamo, CA (US)

(73) Assignee: The Eighth Notch Inc., Alamo, CA (US)

(21) Appl. No.: 17/348,302

(22) Filed: Jun. 15, 2021

Related U.S. Application Data
(60) Provisional application No. 63/040,151, filed on Jun. 17, 2020.

(51) Int. Cl. G06Q 50/28; G06Q 10/06; G06N 20/00; G06F 9/54

(52) U.S. Cl. CPC G06Q 50/28; G06Q 10/06313; G06F 9/54; G06N 20/00; G06Q 10/06315

(57) ABSTRACT

Disclosed embodiments provide a framework to synchronize delivery of shipments from one or more shipping entities or other entities at a delivery carrier to enable consolidation of the shipments for delivery to a recipient. In response to obtaining a recipient request and proposed delivery orders for a set of fulfillment centers, a logistics optimization platform system determines a shipping date for each fulfillment center that allows for arrival of the shipments at a delivery carrier location at a time that allows the delivery carrier to consolidate these shipments into a single delivery for a recipient. The shipping entity can finalize the delivery orders using these shipping dates and provide these delivery orders to the fulfillment centers to fulfill the recipient request and enable the delivery carrier to consolidate the shipments into a single delivery for the recipient.

### CROSS-REFERENCE TO RELATED APPLICATIONS

The present application claims the priority benefit of U.S. Provisional application Ser. No. 63/040,151, filed Jun. 17, 2020, the disclosure of which is incorporated herein by reference.

### FIELD

The present disclosure relates generally to systems and methods for consolidating shipments at a destination to optimize delivery of these shipments. In one example, the systems and methods described herein may be used to identify and engineer shipping dates to ensure shipments are consolidated and to synchronize delivery of these shipments among different shipping entities.

### SUMMARY

Disclosed embodiments may provide a framework to engineer shipping dates for recipient orders to ensure that shipments destined to the recipient are delivered synchronously. The shipping dates for shipments from different fulfillment centers are synchronized such that the shipments arrive at a delivery carrier for delivery to the recipient in a single delivery. Further, shipments destined for a particular recipient are synchronized across various shipping entities based on shipping information provided by a delivery carrier. Options for optimized shipping dates may be provided to the recipient to allow the recipient to have all deliveries across multiple shipping entities provided in a single delivery from a delivery carrier.

According to some embodiments, a computer-implemented method is provided. The method comprises receiving, by a computer system, a request to obtain a set of items and a set of delivery orders, wherein the request indicates an address of a recipient for delivery of the set of items, and wherein the set of delivery orders correspond to a set of fulfillment centers tasked with fulfilling the request. The method further comprises obtaining, by the computer system, a set of transit tables of a delivery carrier, wherein the set of transit tables specify transit times from the set of fulfillment centers to a distribution center of the delivery carrier. Additionally, the method comprises determining, by the computer system, shipping dates for the set of fulfillment centers, wherein the shipping dates are determined based on the transit times, and wherein the shipping dates correspond to a date in which the set of items are to arrive at the distribution center. The method further comprises providing, by the computer system, the set of delivery orders and the shipping dates to cause the set of fulfillment centers to fulfill the request in accordance with the shipping dates to cause the delivery carrier to consolidate the set of items at the distribution center for the delivery to the recipient.

According to some embodiments, a computer-program product is provided. The computer-program product is tangibly embodied in a non-transitory machine-readable storage medium, including instructions that, when executed by one or more processors, cause the one or more processors to perform the steps of the above method.

According to some embodiments, a system is provided. The system comprises one or more processors, and one or more non-transitory machine-readable storage media containing instructions that, when executed on the one or more processors, cause the one or more processors to perform operations including the steps of the above method.

This summary is not intended to identify key or essential features of the claimed subject matter, nor is it intended to be used in isolation to determine the scope of the claimed subject matter. The subject matter should be understood by reference to appropriate portions of the entire specification of this patent application, any or all drawings, and each claim.

The foregoing, together with other features and examples, will be described in more detail below in the following specification, claims, and accompanying drawings.

### BRIEF DESCRIPTION OF THE DRAWINGS

Illustrative embodiments are described in detail below with reference to the following figures.

FIG. 1 shows an illustrative example of an environment in which a logistics optimization platform system generates a set of shipment dates for delivery orders to a set of fulfillment centers based at least in part on transit information from a delivery carrier in accordance with at least one embodiment;

FIG. 2 shows an illustrative example of an environment in which a logistics optimization platform system synchronizes delivery orders of a recipient across a set of shipping entities to allow consolidated delivery of recipient shipments from a delivery carrier in accordance with at least one embodiment;

FIG. 3 shows an illustrative example of an environment in which a logistics optimization platform system is implemented using a multi-tenant infrastructure to allow multiple shipping entities to utilize the logistics optimization platform system concurrently in accordance with at least one embodiment;

FIG. 4 shows an illustrative example of an environment in which a shipping entity provides, through a graphical user interface (GUI), a set of expanded options to a recipient for consolidating deliveries on a particular delivery date in accordance with at least one embodiment;

FIG. 5 shows an illustrative example of an environment in which a shipping entity provides, through a GUI, a set of specific date selection options to a recipient for consolidating deliveries on a specific date in accordance with at least one embodiment;

FIG. 6 shows an illustrative example of an environment in which a shipping entity provides, through a GUI, a set of personalized recipient options for consolidated deliveries based at least in part on past order history in accordance with at least one embodiment;

FIG. 7 shows an illustrative example of a process for determining shipping dates for fulfillment centers of a shipping entity based on shipment transit times from the fulfillment centers to a delivery carrier in accordance with at least one embodiment;

FIG. 8 shows an illustrative example of a process for determining shipping dates for fulfillment centers of a shipping entity based on shipment transit times of the fulfillment centers and pending deliveries from other shipping entities in accordance with at least one embodiment; and

FIG. 9 shows a computing system architecture including various components in electrical communication with each other using a connection in accordance with various embodiments.

In the appended figures, similar components and/or features can have the same reference label. Further, various components of the same type can be distinguished by following the reference label by a dash and a second label that distinguishes among the similar components. If only the first reference label is used in the specification, the description is applicable to any one of the similar components having the same first reference label irrespective of the second reference label.

### DETAILED DESCRIPTION

In the following description, for the purposes of explanation, specific details are set forth in order to provide a thorough understanding of certain inventive embodiments. However, it will be apparent that various embodiments may be practiced without these specific details. The figures and description are not intended to be restrictive. The word “exemplary” is used herein to mean “serving as an example, instance, or illustration.” Any embodiment or design described herein as “exemplary” is not necessarily to be construed as preferred or advantageous over other embodiments or designs.

Disclosed embodiments may provide a framework to synchronize delivery of shipments from one or more shipping entities or other entities at a delivery carrier to enable consolidation of the shipments for delivery to a recipient. For example, in response to obtaining a recipient request from a recipient, a shipping entity may identify one or more fulfillment centers or shipping locations (stores, vendor owned locations, etc.) that may fulfill the recipient request and generate initial delivery orders for these locations. The shipping entity may provide the customer request and the proposed delivery orders to a logistics optimization platform system, which may determine, for each fulfillment center, a shipping date that allows for arrival of the shipment at a delivery carrier location along with other shipments from other fulfillment centers at a time that allows the delivery carrier to consolidate these shipments into a single delivery for a recipient. To identify these shipping dates, the logistics optimization platform system utilizes a set of rules corresponding to operation of each fulfillment center in order to execute the shipment and may obtain one or more transit tables from the delivery carrier. These transit tables may be used to identify the delivery carrier transit time for shipments from each fulfillment center to the location indicated by the recipient for delivery of its order. Based on these defined rules and transit times, the logistics optimization platform system may calculate the shipping dates for each fulfillment center and provide these shipping dates to the shipping entity. The shipping entity may finalize the delivery orders using these shipping dates and provide these delivery orders to the fulfillment centers to fulfill the recipient request.

Shipping entities define the delivery date or date range for items ordered by the recipient. These items may be maintained by the shipping entity or other organization in different fulfillment centers located in different geographic regions. This can result in different items destined for the recipient to be delivered in multiple deliveries, as these different items may arrive at a delivery carrier at different times from the different fulfillment centers. Further, shipping entities and other organizations often do not have visibility with regard to other deliveries that may be scheduled for the same recipient from other shipping entities, which may result in multiple deliveries being made to the recipient. This creates significant inefficiencies for these shipping entities, as well as for the delivery carrier, as orders may fulfilled using multiple delivery stops as opposed to a singular delivery stop.

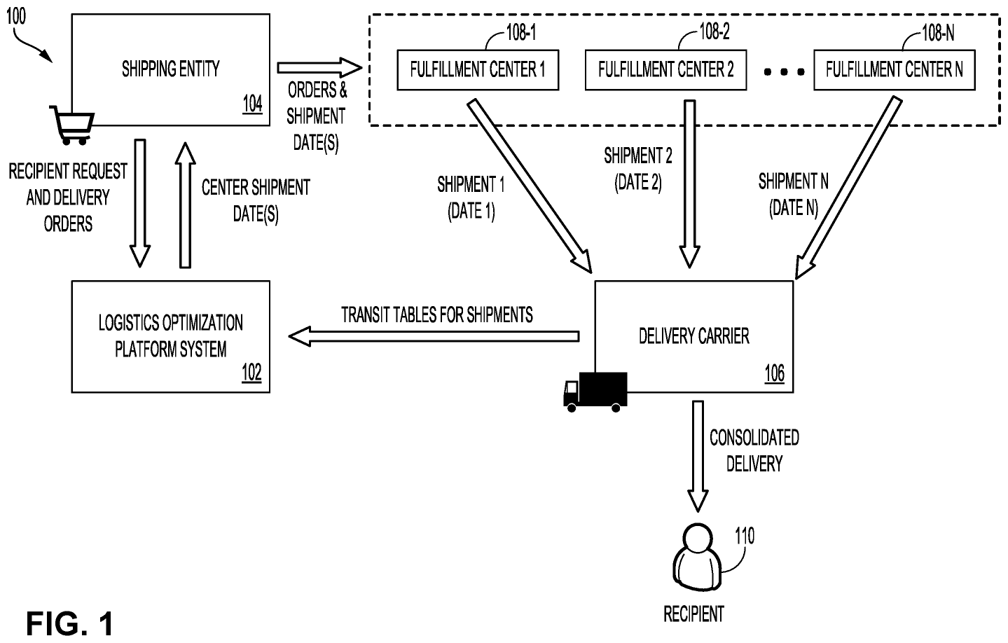

FIG. 1 shows an illustrative example of an environment 100 in which a logistics optimization platform system 102 generates a set of shipment dates for delivery orders to a set of fulfillment centers 108-1-108-N based at least in part on transit information from a delivery carrier 106 in accordance with at least one embodiment. In the environment 100, a shipping entity 104 transmits a request to a logistics optimization platform system 102 to identify one or more shipment dates for a set of fulfillment centers 108-1-108-N for fulfillment of a recipient request of a recipient 110. The recipient request may specify a target delivery date for delivery or a window of dates within which a guarantee or promise is made to the recipient 110 for delivery. The logistics optimization platform system 102 may be implemented using one or more computer systems that are configured to engineer and orchestrate shipping dates for various fulfillment centers to allow for consolidation of shipments from these fulfillment centers at a delivery carrier 106. The consolidation of shipments at the delivery carrier 106 may provide certain benefits. For instance, rather than having to conduct multiple deliveries to a recipient 110 at a particular address for items from a recipient request, the different items may be consolidated at the delivery carrier 106 and allow for delivery of these items to the recipient 110 in a single delivery.

In an embodiment, to access the logistics optimization platform system 102, the shipping entity 104 calls a representational state transfer (REST) application programming interface (API) of the logistics optimization platform system 102. In this REST API call, the shipping entity 104 may provide a set of credentials that may be used to authenticate the shipping entity 104. For example, in the REST API call, the shipping entity 104 may provide its username and corresponding password to the logistics optimization platform system 102. The logistics optimization platform system 102 may evaluate the provided credentials to determine whether the credentials are valid. If so, the logistics optimization platform system 102 may provide the shipping entity 104 with an access token that may be used by the shipping entity 104 to access the logistics optimization platform system 102 without providing its credentials for a period of time (e.g., until the access token expires).

In response to obtaining a recipient request from a recipient 110, the shipping entity 104 may identify the one or more fulfillment centers 108-1-108-N that may be used to fulfill the recipient request. The fulfillment centers 108-1-108-N of the shipping entity 104 may be located in different geographic locations. For instance, each fulfillment center 108-1-108-N may be assigned to maintain and deliver certain items or classes of items on behalf of the shipping entity 104. Alternatively, a fulfillment center 108-1-108-N may maintain certain items or classes of items that are subject to greater demand within a particular geographic region serviced by the fulfillment center 108-1-108-N. Fulfillment centers 108-1-108-N may further be located near delivery carrier hubs, through which shipments are transited to local delivery carrier locations for delivery to recipients. Fulfillment centers 108-1-108-N may also be located at or near facilities that manufacture or otherwise import the items sold by the shipping entity and distributed to its recipients. Thus, a set of items ordered by a recipient 110 may be maintained in different fulfillment centers and in different geographic regions.

The shipping entity 104 may generate one or more delivery orders that are to be submitted to the identified fulfillment centers 108-1-108-N for fulfillment of the recipient request submitted by the recipient 110. A delivery order may indicate which items are to be included in a shipment to the delivery carrier 106 for delivery to the recipient 110. In its request to the logistics optimization platform system 102 to identify the shipping dates for each of the identified fulfillment centers 108-1-108-N, the shipping entity 104 may include the delivery orders for the fulfillment centers 108-1-108-N and the recipient request submitted by the recipient 110. Further, in an embodiment, the shipping entity 104 provides performance metrics for each of the fulfillment centers 108-1-108-N. The performance metrics may indicate the efficiency of each of the fulfillment centers 108-1-108-N in processing and preparing a shipment for delivery to a delivery carrier 106. For instance, the performance metrics may specify a rate in which a fulfillment center is able to ship a shipment to the delivery carrier 106 on time. Further, the performance metrics may specify an average delay time for each fulfillment center in preparing a shipment for delivery.

These performance metrics may, thus, be used to identify possible shipment dates from the fulfillment centers 108-1-108-N to the delivery carrier 106.

In an embodiment, a shipping entity 104 provides, to the logistics optimization platform system 102, a set of rules corresponding to operation of the fulfillment centers 108-1-108-N and of the shipping entity 104 itself that can be used by the logistics optimization platform system 102 to identify the shipping date for each of the fulfillment centers 108-1-108-N that would allow for consolidation of the shipments from these fulfillment centers 108-1-108-N at the delivery carrier 106 for delivery of the items in the recipient request to the recipient 110. For example, the set of rules may specify a maximum number of orders that can be processed by a fulfillment center per day. As another example, the set of rules may specify a timeframe within each day during which shipments may be made from each fulfillment center of the shipping entity 104.

The logistics optimization platform system 102, in response to the request from the shipping entity 104, may evaluate the set of rules defined by the shipping entity 104, as well as a set of transit tables from the delivery carrier 106, and a set of performance metrics for each fulfillment center, to determine whether consolidation of shipments corresponding to the recipient request can be performed on a target date specified in the recipient request. For instance, if the logistics optimization platform system 102 identifies a potential date for shipment from a fulfillment center to a delivery carrier 106 distribution center or other hub, the logistics optimization platform system 102 may determine, based on the set of rules defined by the shipping entity 104, whether the fulfillment center may initiate the shipment on the potential date. For example, if the fulfillment center has reached its quota for shipments per day and/or the shipment would commence outside of the pre-defined shipment timeframe specified in the set of rules, the logistics optimization platform system 102 may determine that shipment from the fulfillment center may not be performed on the potential shipping date. This may result in the logistics optimization platform system 102 determining whether consolidation of shipments from the myriad fulfillment centers may still be performed subject to the target date specified in the recipient request.

In response to the request from the shipping entity 104, the logistics optimization platform system 102 may review a set of transit tables from the delivery carrier 106 to identify the estimated transit time from each of the fulfillment centers 108-1-108-N to the address or other location specified by the recipient 110 where fulfillment of the recipient's order is to be made. This set of transit tables may specify the delivery carrier transit times from different geographic locations (e.g., an origin zip code, etc.) to different destinations (e.g., a destination zip code associated with the address or other location specified by the recipient 110 in its order). Alternatively, the logistics optimization platform system 102 may utilize the set of transit tables to identify the estimated transit time from each of the fulfillment centers 108-1-108-N to a distribution center or hub of the delivery carrier 106 wherein the shipments of the fulfillment centers 108-1-108-N are to be consolidated and prepared for delivery to the recipient 110.

A transit table may indicate the average transit time from a location within a particular zip code to another location (e.g., a recipient 110 address, etc.) within another zip code. Using these transit tables and a defined set of rules from the shipping entity 104 for execution of the shipment, as well as the address provided by the recipient 110 in its recipient request, the logistics optimization platform system 102 may calculate the transit time from each of the fulfillment centers 108-1-108-N specified in the delivery orders provided by the shipping entity 104 to the local delivery carrier location or distribution center that will be tasked with delivery of the items specified in the recipient request to the recipient 110 at the specified address.

In an embodiment, based on these identified transit times, the defined set of rules from the shipping entity 104, the performance metrics provided by the shipping entity 104 for each of the fulfillment centers 108-1-108-N, and/or a carrier-provided delivery date of other shipping entities that may have shipments for delivery to the recipient's address, the logistics optimization platform system 102 may determine the shipping date for each of the fulfillment centers 108-1-108-N that would allow for consolidation of the shipments from these fulfillment centers 108-1-108-N at the delivery carrier 106 for delivery of the items in the recipient request to the recipient 110 in a single delivery. In an embodiment, the logistics optimization platform system 102 utilizes a machine learning algorithm or model to identify the shipping dates for each of the fulfillment centers 108-1-108-N. As input, the machine learning algorithm or model may utilize the transit times identified by the logistics optimization platform system 102, the performance metrics supplied by the shipping entity 104, any historical order data for the recipient shipping address (e.g., past orders, previously selected dates and delivery options, etc.), and performance metrics corresponding to fulfillment of previous recipient requests of the recipient 110 (e.g., accuracy in delivering items associated with previous recipient requests within promised delivery dates, etc.). The output generated by the machine learning algorithm or model may include the shipping dates for the fulfillment centers 108-1-108-N.

The logistics optimization platform system 102 may provide the identified shipping dates for the fulfillment centers 108-1-108-N to the shipping entity 104 to fulfill the request from the shipping entity 104. This may cause the shipping entity 104 to finalize the delivery orders for the fulfillment centers 108-1-108-N. For instance, each delivery order may indicate the shipping date for the corresponding fulfillment center to initiate transit of a shipment from the fulfillment center to the delivery carrier 106 for consolidation with other shipments from other fulfillment centers. In an embodiment, the shipping entity 104 transmits the delivery orders to the fulfillment centers 108-1-108-N concurrently such that the fulfillment centers 108-1-108-N may obtain their respective delivery orders at the same time. Alternatively, the shipping entity 104 may stagger transmission of the delivery orders to the fulfillment centers 108-1-108-N according to the shipping dates identified by the logistics optimization platform system 102.

In an embodiment, the logistics optimization platform system 102 generates a set of analytics or other data that can be used to identify potential optimizations to the operation of the shipping entity 104 in providing shipments to recipients, such as recipient 110. For instance, if the logistics optimization platform system 102 determines that a target delivery date specified by the recipient 110 cannot be met as a result of one or more rules defined by the shipping entity 104, the logistics optimization platform system 102 may utilize a machine learning model to simulate alternative scenarios whereby different rules are defined that allow for delivery to the recipient 110 on or prior to the target delivery date. For instance, if a rule defined by the shipping entity 104 indicates that each fulfillment center 108-1-108-N is subject to a shipment limit, whereby no additional shipments may be made from a fulfillment center once the limit is reached, the logistics optimization platform system 102 may adjust this shipment limit to determine whether additional opportunities for consolidation of shipments become apparent and/or to determine whether the target delivery date may be met as a result of a change to the limit. As another example, if a set of rules from the shipping entity 104 indicates that the logistics optimization platform system 102 is to continue querying for pending deliveries that may be used for consolidation with a pending shipment from the shipping entity 104 to the recipient 110 for a period of time, the logistics optimization platform system 102 may simulate this querying beyond the pre-defined period of time to determine whether additional delivery consolidation opportunities become available.

The logistics optimization platform system 102, based on the set of simulations performed using a modified set of rules (wherein the modified set of rules are generated by changing one or more parameters of the rules defined by the shipping entity 104), may generate one or more recommendations for the shipping entity 104 to optimize the delivery date offerings that may be provided to recipients. For instance, the logistics optimization platform system 102 may identify optimizations to the operation of the shipping entity 104 based on individual changes to parameters of the set of rules provided by the shipping entity 104. As an example, if the shipping entity 104 were to modify a rule to change the time limit for obtaining recipient requests that can then be provided to a fulfillment center on the same day as the recipient requests, the logistics optimization platform system 102 may qualify and quantify the benefit to the shipping entity 104 through presentation of cost savings (e.g., via consolidation of shipments for recipients) and other benefits (delivery carrier incentives for increased consolidation of shipments, etc.). The logistics optimization platform system 102 may provide these analytics to the shipping entity 104, which may allow the shipping entity 104 to apply changes to its set of rules based on the analytics provided by the logistics optimization platform system 102.

In an embodiment, the logistics optimization platform system 102 can process requests to identify a target pickup date for shipments from a recipient 110 to the shipping entity 104 based on any pending deliveries to be made to the recipient 110. For instance, a recipient 110 may submit a request to a shipping entity 104 to return a shipment to the shipping entity 104 in order to obtain a refund from the shipping entity 104, exchange the shipment for another item, or for any other purpose. In response to the request from the recipient 110, the shipping entity 104 may submit a request to the logistics optimization platform system 102 to determine whether any deliveries are scheduled to be made at the recipient's location.

The request to the logistics optimization platform system 102 may include a set of rules defined by the shipping entity 104 that may be used to determine whether a shipment may be obtained from a recipient 110 by the delivery carrier 106 concurrently with a delivery that is to be made to the recipient 110 by the delivery carrier 106. The set of rules may specify a time limitation from the date of receipt of the recipient's request for obtaining the shipment from the recipient 110. For example, the shipping entity 104 may indicate, via the set of rules, that the shipment from the recipient 110 is to be obtained within a certain number of days from the date in which the recipient 110 submitted its request to return the shipment to the shipping entity 104.

In response to the request from the shipping entity 104, the logistics optimization platform system 102 may determine whether there are any scheduled deliveries that are to be made by the delivery carrier 106 to the recipient 110 at an address or location specified by the recipient 110. For instance, the logistics optimization platform system 102 may query the delivery carrier 106 to identify any scheduled deliveries that are to be made to the recipient 110 at the address or location specified by the recipient 110. Alternatively, the logistics optimization platform system 102 may query a shipment orchestration system maintained by the logistics optimization platform system 102 to identify any pending delivery dates for deliveries that are to be made to the recipient 110 from the shipping entity 104 or any other shipping entity associated with the logistics optimization platform system 102. If the logistics optimization platform system 102 determines that no deliveries are scheduled to be made to the recipient 110, the logistics optimization platform system 102 may evaluate the set of rules provided by the shipping entity 104 to identify a pickup date at which the delivery carrier 106 is to obtain the shipment from the recipient 110 and initial delivery of the shipment to the shipping entity 104 (e.g., at a fulfillment center of the shipping entity 104, other location designated by the shipping entity 104 for delivery of returned items, etc.). In an embodiment, the logistics optimization platform system 102 transmits a request to the delivery carrier 106 to identify, in accordance with the set of rules provided by the shipping entity 104, a date at which the delivery carrier 106 may retrieve the shipment from the recipient 110. For instance, the delivery carrier 106 may identify a date in which a delivery is scheduled to be made within the vicinity of the recipient's specified location. The delivery carrier 106 may provide this information to the logistics optimization platform system 102, which may use this information to select a retrieval date for the shipment from the recipient 110.

In an embodiment, if the logistics optimization platform system 102 identifies one or more delivery dates for shipments from the shipping entity 104 and/or other shipping entities to the recipient 110 at the address or location specified by the recipient 110 in its request to the shipping entity 104, the logistics optimization platform system 102 determines whether any of the one or more delivery dates satisfy the set of rules provided by the shipping entity 104 for retrieval of the recipient's shipment that is to be returned to the shipping entity 104. For instance, if the set of rules specify a final date for return of a shipment from the recipient 110 to the shipping entity 104, the logistics optimization platform system 102 may determine whether the one or more delivery dates corresponding to deliveries that are to be made to the recipient 110 are prior to this final date and, if so, whether delivery of the shipment from the recipient 110 to the shipping entity 104 may be completed prior to or on the final date as identified based on the set of rules.

If the logistics optimization platform system 102 identifies a delivery date that satisfies the set of rules provided by the shipping entity 104 to allow for retrieval of a shipment from the recipient 110 to the shipping entity 104, the logistics optimization platform system 102 may provide a response to the shipping entity 104 that includes this date. This may allow the shipping entity 104 to indicate, to the recipient 110, that the shipment from the recipient 110 may be retrieved by the delivery carrier 106 on the specified date for delivery to the shipping entity 104. If the recipient 110 confirms that this specified date is acceptable, the shipping entity 104 may transmit a confirmation to the logistics optimization platform system 102 for retrieval of the shipment from the recipient 110. In response to this confirmation, the logistics optimization platform system 102 may transmit a notification to the delivery carrier 106 to indicate that a shipment from the recipient 110 is to be retrieved on the specified date and during delivery of other shipments to the recipient 110 from the shipping entity 104 and/or other shipping entities

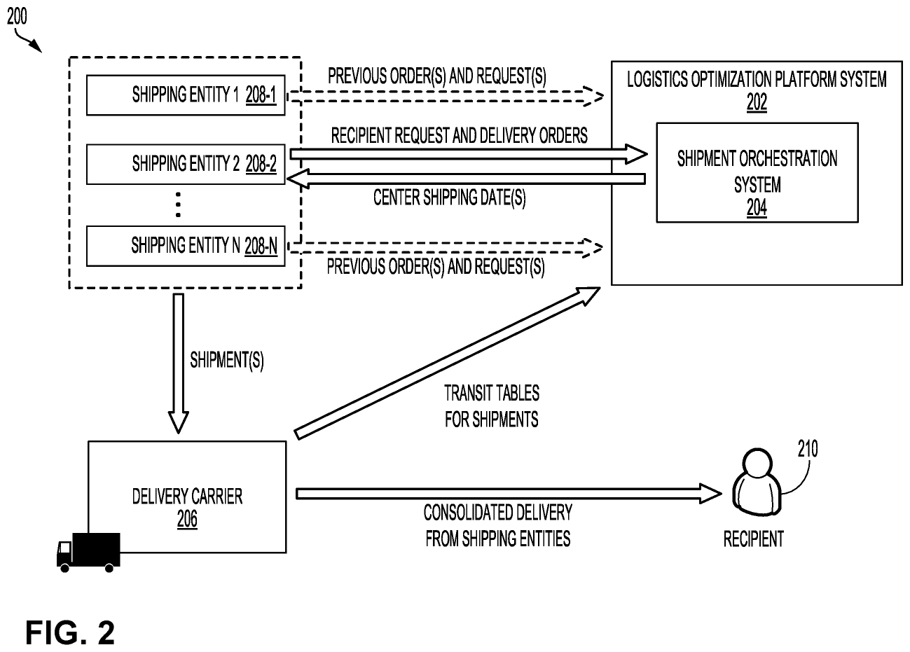

FIG. 2 shows an illustrative example of an environment 200 in which a logistics optimization platform system 202 synchronizes delivery orders of a recipient across a set of shipping entities 208-1-208-N to allow consolidated delivery of shipments from a delivery carrier 206 in accordance with at least one embodiment. In the environment 200, a shipping entity 208-2 accesses the logistics optimization platform system 202 to identify a shipping date for each of its fulfillment centers that are tasked to fulfill an order. For instance, when a recipient submits an order to the shipping entity 208-2, the shipping entity 208-2 may identify one or more fulfillment centers that may fulfill the request. Each fulfillment center may maintain and ship particular items and/or classes of items to different local delivery carrier locations or distribution centers for the delivery to the recipient of the shipping entity 208-2. The fulfillment centers of the shipping entity 208-2 may be located in different geographic locations. Further, a fulfillment center may maintain certain items or classes of items that are subject to greater demand within a particular geographic region serviced by the fulfillment center. Fulfillment centers may further be located near delivery carrier hubs, through which shipments are transited to local delivery carrier locations for delivery to the recipient. Fulfillment centers may also be located at or near facilities that manufacture or otherwise import the items sold by the shipping entity 208-2 and distributed to its recipients. Thus, a set of items ordered by a recipient may be maintained in different fulfillment centers and in different geographic regions. The shipping entity 208-2 may define one or more delivery orders that are to be provided to the identified fulfillment centers, which may use these delivery orders to select its assigned items and ship these assigned items to the local delivery carrier location or distribution center.

The shipping entity 208-2 may provide the recipient request and delivery orders for a particular recipient to a shipment orchestration system 204 of the logistics optimization platform system 202. The shipment orchestration system 204 is a SaaS based system that can be accessed by a shipping entity via authorized API service calls The shipment orchestration system 204 may be configured to identify one or more shipping dates for each fulfillment center of a shipping entity 208-2 based on a set of transit tables from a delivery carrier 206, and a defined set of rules that each shipping location needs; as well as any dates corresponding to pending deliveries scheduled for the recipient 210.

In an embodiment, in response to obtaining the sales and delivery orders from the shipping entity 208-2, the shipment orchestration system 204 obtains a set of transit tables from the delivery carrier 206. This set of transit tables may specify the transit times for an origin and destination zip For instance, a transit table may indicate the transit time from a location within a particular zip code of a distribution center of the shipping entity to the zip code of the recipient. Using these transit tables, as well as the address provided by the recipient 210 in its recipient request, the shipment orchestration system 204 may calculate the transit time from each of the fulfillment centers specified in the delivery orders to the delivery of the items specified in the recipient request to the recipient 210 at the specified address.

In an embodiment, the shipment orchestration system 204 queries the delivery carrier 206 to identify any pending deliveries scheduled for the recipient 210 at the address specified in the recipient request provided by the shipping entity 208-2. For instance, in response to previous orders from other shipping entities (e.g., shipping entity 208-1 and shipping entity 208-N), the shipment orchestration system 204 may have provided shipping dates for the fulfillment centers of these other shipping entities. The delivery carrier 206 may obtain, from these other shipping entities, information indicating the pendency of shipments from these fulfillment centers. This information may include the delivery date to the recipient 210. In an embodiment, the shipment orchestration system 204 maintains delivery dates for shipments to the recipient 210 at the specified address for other shipping entities. These other shipping entities may also utilize the logistics optimization platform system 202 to coordinate and synchronize delivery of their shipments to recipients. However, these other shipping entities may otherwise be unrelated to shipping entity 208-2.

Based on the pending delivery dates for shipments from other shipping entities, and the transit tables provided by the delivery carrier 206, and a defined set of rules the shipment orchestration system 204 may determine whether there are any opportunities to consolidate these shipments from other shipping entities with the recipient request from shipping entity 208-2 to allow for a single delivery to the recipient 210 at the provided address. For instance, if the order indicates a preferred delivery date or date range, the shipment orchestration system 204 may determine, based on the transit times for the fulfillment centers of the shipping entity 208-2, whether the shipments from these fulfillment centers will arrive at the delivery carrier 206 in time to allow for consolidation with the pending deliveries from these other shipping entities. If so, the shipment orchestration system 204 may define a shipping date for each fulfillment center of the shipping entity 208-2 that is to fulfill the request to allow for the shipments from these fulfillment centers to be consolidated at the recipient's address 210.

In an embodiment, the shipment orchestration system 204 provides the shipping entity 208-2 with various delivery date options that allow for consolidation of the recipient request with other shipments from other shipping entities (e.g., shipping entity 208-1, shipping entity 208-N). For instance, rather than providing a completed recipient request, the shipping entity 208-2 may provide proposed sales and delivery orders of a recipient 210.

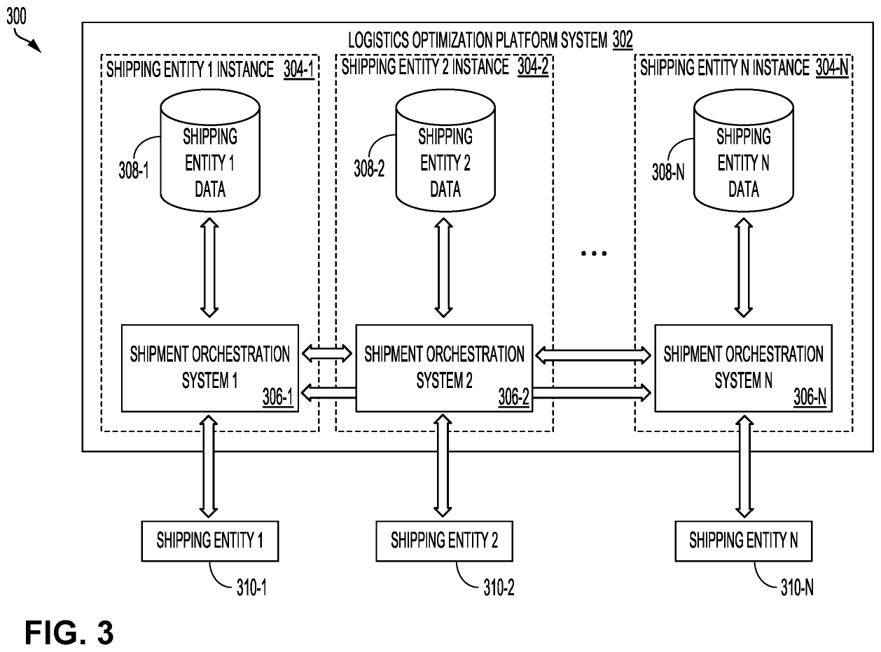

FIG. 3 shows an illustrative example of an environment 300 in which a logistics optimization platform system 302 is implemented using a multi-tenant infrastructure to allow multiple shipping entities 310-1-310-N to utilize the logistics optimization platform system 302 concurrently in accordance with at least one embodiment. In the environment 300, the logistics optimization platform system 302 may be implemented in a cloud environment that is scalable to support the needs of the logistics optimization platform system 302. The cloud environment may be provided by a computing resource service provider that offers high availability, resilience, fault tolerance, and other critical enterprise-grade capabilities to allow for multi-tenant use of the logistics optimization platform system 302 by various shipping entities 310-1-310-N.

Each shipping entity 310-1-310-N may interact with its own instance 304-1-304-N, respectively, of the logistics optimization platform system 302. These instances 304-1-304-N may be implemented as virtual machine instances, virtualized containers, or other virtualized resources made available by a computing resource service provider that implements the cloud environment for the logistics optimization platform system 302. As the demand for use of the logistics optimization platform system 302 increases (e.g., additional shipping entities are accessing the logistics optimization platform system 302), the computing resource service provider may provision additional instances to support this additional demand for these shipping entities. Thus, the resources utilized by the logistics optimization platform system 302 may scale automatically with the increase in demand or load on the logistics optimization platform system 302.

In an embodiment, each instance 304-1-304-N includes a shipment orchestration system 306-1-306-N and shipping entity database 308-1-308-N. A shipment orchestration system may be configured to process incoming requests from a shipping entity to identify one or more delivery dates for a recipient request submitted to the shipping entity by a recipient. Further, the shipment orchestration system may provide shipment dates for each of the fulfillment centers of the shipping entity that are to collectively fulfill the recipient request. These shipment dates may be determined based on the transit times from the fulfillment centers to a local delivery carrier location (e.g., distribution center) from which a delivery may be made to the recipient. Further, these shipment dates may be determined such that shipments from these fulfillment centers arrive at the local delivery carrier location at a time that allows the delivery carrier to consolidate these shipments into a single delivery that can be provided to the recipient on a particular date as specified by the recipient, determined by the shipping entity, or determined by the shipment orchestration system.

The shipping entity database 308-1-308-N may include information specific to the corresponding shipping entity 310-1-310-N, respectively, that may be used by the shipment orchestration system 306-1-306-N to identify the shipment dates for each fulfillment center, as well as possible delivery dates for recipient requests based on recipient preferences and historical data. For instance, a shipping entity database may include historical data and preferences for each recipient of a shipping entity. This historical data may include previous recipient requests fulfilled by the shipping entity, addresses to which deliveries were provided to the recipient, the delivery options selected by the recipient for each previous recipient request, and the like. Further, the shipping entity database may include performance metrics for each of the fulfillment centers of the shipping entity. These performance metrics may include a score corresponding to the rate in which a fulfillment center is able to ship items to the delivery carrier on time and as scheduled. Further, the performance metrics may indicate a score corresponding to the rate in which deliveries to the recipient were made according to the delivery date provided to the recipient as opposed to other dates, whether prior to or after the delivery date provided to the recipient. The performance metrics and historical data from the shipping entity database may be used by the shipment orchestration system to determine the shipping dates for each fulfillment center of the shipping entity that is to fulfill a recipient request of a recipient to ensure that the shipments from these fulfillment centers arrive at a local delivery carrier location for consolidation and delivery to the recipient at a date indicated to the recipient by the shipping entity.

In an embodiment, each shipment orchestration system 306-1-306-N may be in communication with the other shipment orchestration systems of the logistics optimization platform system 302 to identify potential efficiencies for consolidating deliveries among different shipping entities 310-1-310-N. For instance, given a delivery date for a recipient request provided by a shipping entity, the shipment orchestration system may query the other shipment orchestration systems of other shipping entity instances to determine whether other deliveries are scheduled to occur at the address specified in the recipient request. If so, the shipment orchestration system may determine the one or more dates of these other deliveries and, based on these one or more dates, identify any potential opportunities for consolidating the recipient request with any of the one or more other deliveries for other shipping entities to the recipient at the specified address. These opportunities may be presented to the recipient via the shipping entity in the form of alternative delivery dates. Further, to incentivize these alternative delivery dates, the recipient may be provided with certain benefits (e.g., free shipping, savings towards a future recipient request, etc.) for selecting one of these alternative delivery dates for its recipient request.

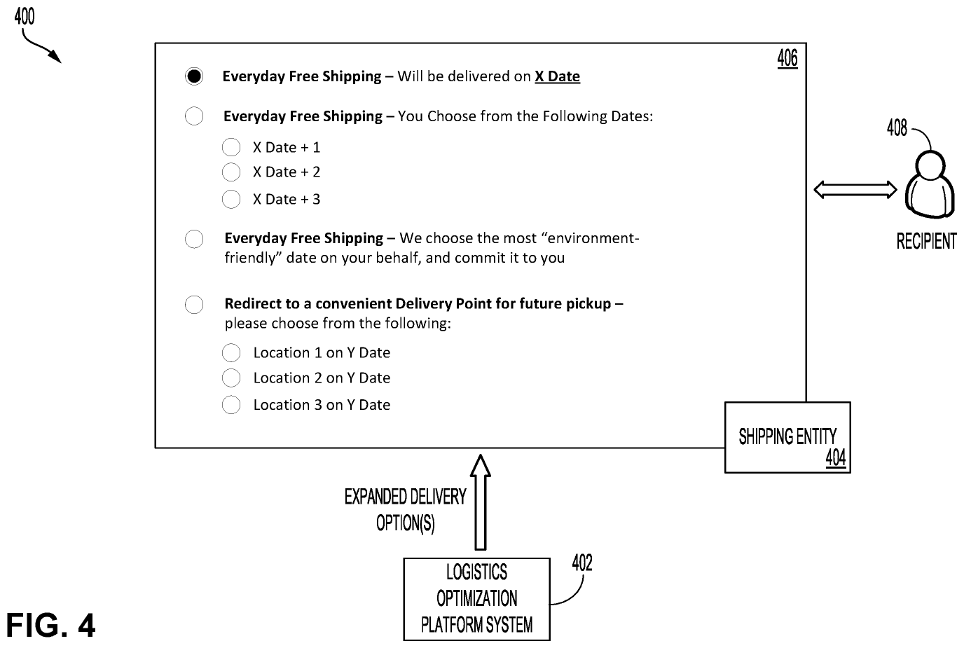

FIG. 4 shows an illustrative example of an environment 400 in which a shipping entity 404 provides, through a GUI 406, a set of expanded options to a recipient 408 for consolidating deliveries on a particular delivery date in accordance with at least one embodiment. In the environment 400, a recipient 408 of the shipping entity 404 may initiate a recipient request for one or more items that are to be delivered to the recipient 408 via a delivery carrier. In an embodiment, the shipping entity 404 is in communication with a logistics optimization platform system 402 in order to identify preferred delivery dates for consolidation of shipments from one or more fulfillment centers of the shipping entity 404 and of shipments from other shipping entities that may be destined to the address provided by the recipient 408 to the shipping entity 404 for delivery of its items.

In an embodiment, in response to receiving a proposed recipient request from a recipient 408, the shipping entity 404 determines which fulfillment centers can be used to fulfill the recipient request and provide shipments to the delivery carrier for delivery to the recipient 408. For instance, the shipping entity 404 may identify, for each item selected by the recipient 408, which fulfillment center maintains the item and is tasked with making the item available for shipment to the recipient 408. These fulfillment centers may be located in different geographic regions and, thus, may have different transit times to the delivery carrier at a local delivery carrier location that services the geographic region including the address provided by the recipient 408. The shipping entity 404 may provide the proposed recipient request and the delivery orders for the identified fulfillment centers to the logistics optimization platform system 402 to identify a set of possible delivery dates for fulfillment of the proposed recipient request from the recipient 408.

In response to obtaining the proposed recipient request and the delivery orders for the identified fulfillment centers, the logistics optimization platform system 402 may determine one or more possible delivery dates for fulfillment of the proposed recipient request. The logistics optimization platform system 402 may obtain one or more transit tables from a delivery carrier that may provide transit times from various locations to different local delivery carrier locations (e.g., distribution centers). To obtain these transit tables, the logistics optimization platform system may transmit a request to the delivery carrier to retrieve the transit tables specific to the geographic region that includes the delivery address provided by the recipient. In this request, the logistics optimization platform system may provide the address specified by the recipient in its recipient request. Alternatively, the logistics optimization platform system may provide information corresponding to this address (e.g., a zip code, a local delivery carrier location at or near the address provided by the recipient, etc.). In some instances, the logistics optimization platform system may access a system or other platform provided by the delivery carrier to obtain the transit tables. In an embodiment, the logistics optimization platform system maintains the transit tables provided by the delivery carrier and, thus, may refer to these transit tables locally. These transit tables may be updated periodically or in response to a triggering event (e.g., service impacts to the delivery carrier resulting from an event, etc.).

The transit tables provided by the delivery carrier or otherwise maintained by the logistics optimization platform system 402 may indicate the transit times for shipments from different locations to each of the local delivery carrier locations from which deliveries may be made within a particular geographic area. In an embodiment, the logistics optimization platform system 402 evaluates the transit tables to determine, for each fulfillment center that is to fulfill the proposed recipient request, the transit time for a shipment from the fulfillment center to the local delivery carrier location that services the address provided by the recipient 408. Since the fulfillment centers of the shipping entity may be located in different geographic locations, the transit times for these fulfillment centers to the local delivery carrier location may differ.

Based on the one or more transit tables, the address provided by the recipient 408, and the location of each fulfillment center that may be tasked to fulfill the proposed recipient request, the logistics optimization platform system 402 may identify one or more possible delivery dates for the recipient request. For instance, based on the identified transit times for each of the fulfillment centers, the logistics optimization platform system 402 may identify the earliest date in which the shipments from these fulfillment centers may arrive at the local delivery carrier location for consolidation and delivery to the recipient 408 at the specified address. The logistics optimization platform system 402 may provide this identified delivery date to the shipping entity 404, which may present this delivery date to the recipient 408 via the GUI 406.

In an embodiment, the logistics optimization platform system 402 can identify additional delivery dates for fulfillment of the recipient request based on pending deliveries to be made to the address provided by the recipient 408. These pending deliveries may correspond to other recipient requests submitted by the recipient 408 via the shipping entity 404 and other shipping entities or entities. For instance, the logistics optimization platform system 402 may query the delivery carrier to determine whether there are any pending deliveries scheduled for the address provided by the recipient 408. If so, the logistics optimization platform system 402 may identify the one or more dates for these pending deliveries. Using these one or more dates, the logistics optimization platform system 402 may determine whether the proposed recipient request may be consolidated with these pending deliveries. For instance, if the one or more dates are after the earliest date in which the proposed recipient request can be fulfilled, the logistics optimization platform system 402 may determine that the proposed recipient request may be consolidated with the pending deliveries to allow for consolidated delivery on any of the one or more dates. However, if the one or more dates are prior to the earliest date in which the proposed recipient request can be fulfilled, the shopping logistics platform system 402 may determine that consolidation of the proposed recipient request with other pending deliveries is not possible.

In an embodiment, in addition to identifying any pending deliveries that may be scheduled for the address provided to the recipient 408, the logistics optimization platform system 402 can identify any pending deliveries scheduled for delivery points of the delivery carrier that may be located near the address provided by the recipient 408. For instance, if the recipient 408 has scheduled delivery of one or more items at a particular delivery point, the logistics optimization platform system 402 may identify the scheduled date for this delivery and determine whether this date is prior to or after the earliest date identified by the logistics optimization platform system 402 for obtaining the shipments from the one or more fulfillment centers of the shipping entity 404. If consolidation of the proposed recipient request with the scheduled delivery may be performed, the logistics optimization platform system 402 may provide, to the shipping entity 404, this proposed date and delivery point location as a possible delivery option for the recipient 408.

Through the GUI 406, the shipping entity 404 may provide the recipient 408 with the various delivery date options identified by the logistics optimization platform system 402. For instance, through the GUI 406, the shipping entity 404 may provide the recipient 408 with an option to have its proposed recipient request fulfilled by the earliest date identified by the logistics optimization platform system 402 subject to no additional shipping fees. Additionally, through the GUI 406, the shipping entity 404 may provide the recipient 408 with any additional delivery dates that may correspond to delivery dates for other pending deliveries that may be consolidated with the proposed recipient request. As illustrated in FIG. 4, the recipient 408 may also be provided with an option to defer to the shipping entity 404 and logistics optimization platform system 402 to select a delivery date for the proposed recipient request on the recipient's behalf. This may provide the logistics optimization platform system 402 with flexibility in identifying an efficient manner in which to consolidate the proposed recipient request with pending deliveries to allow for a single delivery to the specified address on a particular date. The shipping entity 404 may also provide the recipient 408 with an option to redirect delivery of the proposed recipient request to a particular delivery point of the delivery carrier that may be near to the address provided by the recipient 408 and/or to which a pending delivery is scheduled to be made.

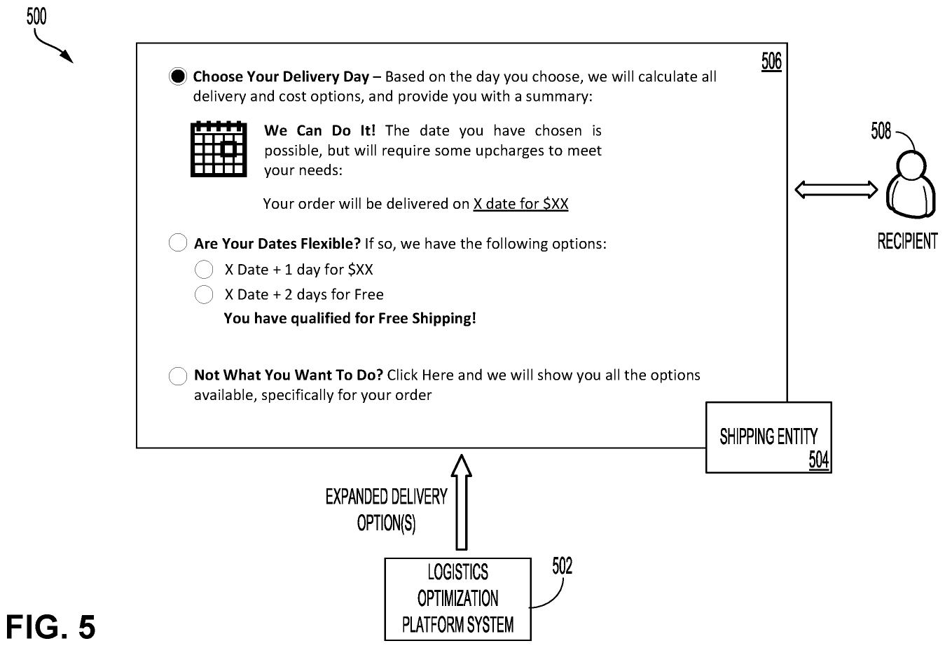

FIG. 5 shows an illustrative example of an environment 500 in which a shipping entity 504 provides, through a GUI 506, a set of specific date selection options to a recipient 508 for consolidating deliveries on a specific date in accordance with at least one embodiment. In the environment 500, a recipient 508 of the shipping entity 504 may initiate a recipient request for one or more items that may be delivered to the recipient 508 via a delivery carrier. As with the shipping entity 404 described above in connection with FIG. 4, the shipping entity 504 may be in communication with a logistics optimization platform system 502, which may operate to provide the shipping entity 504 with various delivery options and dates that may be presented to the recipient 508 to allow the recipient 508 to determine its preferred method of delivery.

In an embodiment, the shipping entity 504, via the GUI 506, provides the recipient 508 with an option to select its preferred delivery day for the items selected by the recipient 508 through the shipping entity 504. For instance, through the GUI 506, the recipient 508 may be presented with various dates from which the recipient 508 may select a preferred date for delivery of the items in the recipient request to be submitted to the shipping entity 504. If the recipient 508 selects a preferred date for delivery of the items, the shipping entity 504 may transmit this preferred date, as well as the address to which the delivery of the items is to be made and the location of any fulfillment centers that may be used to fulfill the recipient request, to the logistics optimization platform system 502 to determine whether this delivery date is feasible. For instance, the logistics optimization platform system 502 may evaluate the one or more transit tables of the delivery carrier to determine whether shipments from the one or more fulfillment centers can be delivered to the local delivery carrier location for consolidation in time to satisfy the recipient's specified delivery date.

If the logistics optimization platform system 502 determines that the delivery date selected by the recipient 508 is feasible, the logistics optimization platform system 502 may determine whether additional expense is required in order to satisfy this delivery date. For instance, if satisfying the delivery date would require additional delivery carrier resources (e.g., air shipments, etc.) in order to fulfill the recipient request, the logistics optimization platform system 502 may identify, from the delivery carrier, the additional expense that may be incurred in order to fulfill the recipient request. Details regarding this additional expense may be provided to the shipping entity 504, which may present this additional expense to the recipient 508 via the GUI 506.

In an embodiment, the logistics optimization platform system 502 can identify other shipments from other shipping entities that are pending delivery to the recipient 508 on alternative dates. For instance, using the address provided by the recipient 508 to the shipping entity 504, the logistics optimization platform system 502 may query the delivery carrier to determine whether any other deliveries are scheduled for this address. Additionally, or alternatively, the logistics optimization platform system 502 may evaluate other recipient requests from the shipping entity 504 and other shipping entities to determine whether any of these other recipient requests are associated with the address provided by the recipient 508. If the logistics optimization platform system 502 determines that other shipments are scheduled for delivery to the address provided by the recipient 508, the logistics optimization platform system 502 may identify the corresponding delivery dates for each of these shipments. Further, the logistics optimization platform system 502 may determine whether there are any opportunities for consolidation of the recipient request being generated by the recipient 508 via the GUI 506 with the pending deliveries corresponding to these other shipments. If the logistics optimization platform system 502 identifies one or more opportunities for consolidation of the recipient request with pending deliveries scheduled for the recipient 508, the logistics optimization platform system 502 may provide the dates corresponding to these opportunities to the shipping entity 504 for presentation to the recipient 506 as alternative delivery dates for its recipient request.

In an embodiment, if the logistics optimization platform system 502 identifies opportunities for consolidation of the recipient request with other pending deliveries for the recipient 508, the logistics optimization platform system 502 can provide the recipient 508 with incentives to alter its preferred delivery date as specified via the GUI 506 with a delivery date corresponding to these other pending deliveries that may allow for consolidation of the recipient request with these pending deliveries. For instance, as illustrated in FIG. 5, the logistics optimization platform system 502 may provide the shipping entity 504 with one or more options for alternative delivery dates that may result in a reduced cost to the recipient 508. Through the GUI 506, the shipping entity 504 may present these alternative delivery dates to the recipient 508, as well as the associated cost of delivery associated with these alternative delivery dates. Through the presentation of any cost savings along with the alternative delivery date options, the recipient 508 may be encouraged to select an alternative delivery date, which may allow for consolidation of shipments from the shipping entity 504 and other shipping entities into a single delivery for the recipient 508.

In some instances, the logistics optimization platform system 502 may determine that the date provided by the recipient 508 is not feasible for fulfillment of the recipient request. For instance, the date selected by the recipient 508 may not allow sufficient time for the fulfillment centers of the shipping entity 504 to prepare and provide the various shipments to the delivery carrier for delivery to the recipient 508. As a result, the logistics optimization platform system 502 may transmit a notification to the shipping entity 504 to indicate that the recipient request cannot be fulfilled by the selected date. This may cause the shipping entity 504 to indicate, via the GUI 506, that the recipient request cannot be fulfilled by the specified date. However, the shipping entity 504 may present the recipient 508 with the alternative delivery dates identified by the logistics optimization platform system 502 as described above. Further, the recipient 508 may be presented with an option to select a different delivery date. If the recipient 508 selects a different delivery date, the shipping entity 504 may provide this different delivery date to the logistics optimization platform system 502, which may perform another evaluation as described above to determine whether this different delivery date is feasible and whether there are any additional opportunities for consolidation of the recipient request with other pending deliveries from the shipping entity 504 and other shipping entities.

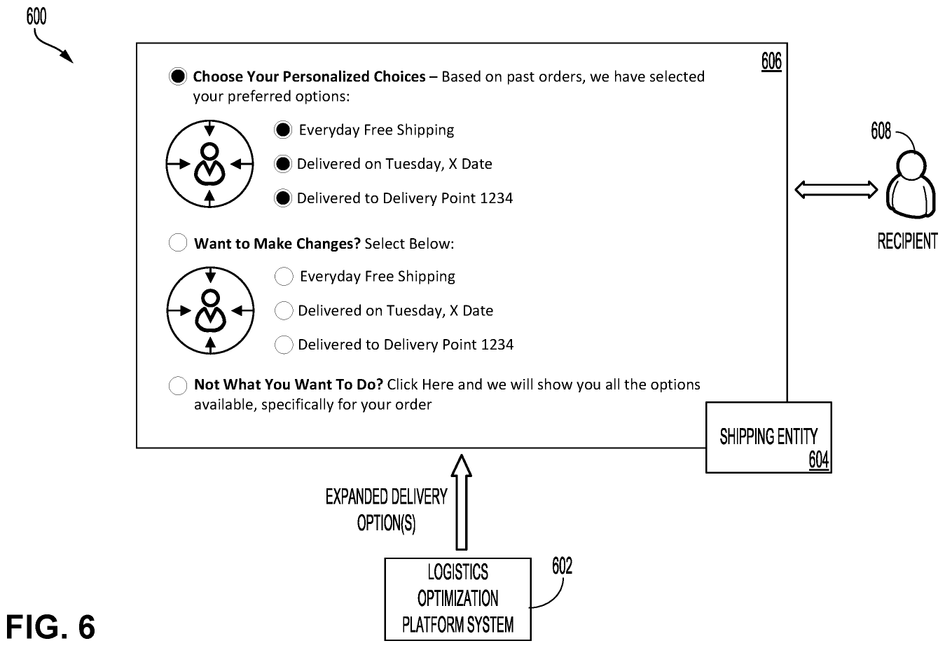

FIG. 6 shows an illustrative example of an environment 600 in which a shipping entity 604 provides, through a GUI 606, a set of personalized recipient options for consolidated deliveries based at least in part on past order history in accordance with at least one embodiment. In the environment 600, a recipient 608 of a shipping entity 604 may initiate a recipient request for one or more items that may be delivered to the recipient 608 via a delivery carrier. The shipping entity 604 may be in communication with a logistics optimization platform system 602, which may operate to provide the shipping entity 604 with various delivery options and dates that may be presented to the recipient 608 to allow the recipient 608 to determine its preferred method of delivery.

In an embodiment, the logistics optimization platform system 602 maintains historical data of the shipping entity 604 as well as of the recipient 608. For example, the logistics optimization platform system 602 may maintain historical data corresponding to prior recipient requests submitted by the recipient 608 to the shipping entity 604 that may have been fulfilled by the shipping entity 604 using the logistics optimization platform system 602. As noted above, in response to obtaining a recipient request from a recipient 608, the shipping entity 604 may interact with the logistics optimization platform system 602 to identify shipping dates for each of the shipping entity's fulfillment centers to ensure that the shipments from these fulfillment centers can be consolidated for performance of a single delivery at a specified date to the address specified by the recipient in its recipient request. The recipient request may include the preferred delivery timeframe for the recipient 608, the items ordered by the recipient 608, the address to which the items are to be delivered, and any other recipient preferences for delivery of the items (e.g., specific day of the week, etc.). The logistics optimization platform system 602 may maintain, for each recipient 608, a record of each recipient request.

As noted above, the logistics optimization platform system 602 may interact with various shipping entities, including shipping entity 604. As such, the logistics optimization platform system 602 may maintain, for each recipient 608, various recipient requests from different shipping entities that are pending or have otherwise been fulfilled. Recipient requests from different shipping entities may be consolidated such that shipments from different shipping entities may be consolidated at a local delivery carrier location to allow for a single delivery of these shipments to the recipient 608 at a specified address or delivery point associated with the delivery carrier. The logistics optimization platform system 602 may maintain recipient requests of a recipient 608 for a period of time, purging any recipient requests that were submitted beyond an expiration time threshold. This may ensure that contemporaneous recipient requests are utilized to identify a recipient's preferences.

Through these different recipient requests, the logistics optimization platform system 602 may identify specific recipient preferences for delivery of its items from all shipping entities and/or from specific shipping entities, such as shipping entity 604. For instance, as illustrated in FIG. 6, the logistics optimization platform system 602 may determine that the recipient 608 prefers free shipping, with deliveries being made on a Tuesday, and to a particular delivery point associated with the delivery carrier as opposed to the recipient's home address. These preferences may be identified based on the recipient requests with various shipping entities associated with the logistics optimization platform system 602 or with the shipping entity 604. The preferences may be provided to the shipping entity 604, which may present these preferences to the recipient 608 via the GUI 606 as the recipient 608 prepares its recipient request for the shipping entity 604.

In an embodiment, the shipping entity 604 provides the recipient 608, through the GUI 606, with one or more options to deviate from the preferences identified by the logistics optimization platform system 602 and selected by default in the GUI 606. For instance, as illustrated in FIG. 6, the GUI 606 may be configured to provide the recipient 608 with options to change from everyday free shipping, from deliveries being performed on Tuesdays, and/or from deliveries being made to a specific delivery point associated with the delivery carrier. If the recipient 608 opts to deviate from the preferences (e.g., personalized choices) identified by the logistics optimization platform system 602, the shipping entity 604 may note these deviations and provide, in the recipient request, the recipient's alternative delivery selections to the logistics optimization platform system 602.

Based on the recipient's selections via the GUI 606, the logistics optimization platform system 602 may revise or reinforce the recipient's preferences maintained in a recipient profile stored by the logistics optimization platform system 602. For example, the logistics optimization platform system 602 may utilize machine learning to identify the recipient's preferences based on prior recipient requests from the shipping entity 604 and from other shipping entities that utilize the logistics optimization platform system 602. As the recipient 608 submits an increasing number of recipient requests with the shipping entity 604 and other shipping entities that utilize the logistics optimization platform system 602, additional data points may be obtained that can be used to reinforce the training of the machine learning model utilized to identify recipient 608 trends and preferences. For instance, if a recipient 608 deviates from the personalized choices or preferences presented via the GUI 606, the logistics optimization platform system 602 may use this deviation as input to the machine learning model to determine whether the recipient's preferences have changed or whether this deviation is an aberration (e.g., isolated instance). Thus, as additional recipient requests are processed for the recipient 608, the logistics optimization platform system 602 may continuously update the recipient's preferences that can be presented to the recipient 608 by the shipping entity 604 and other shipping entities that utilize the logistics optimization platform system 602.

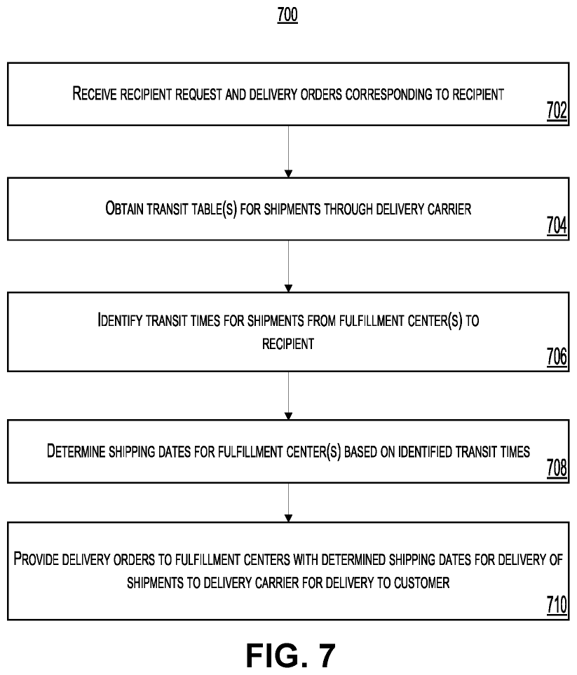

FIG. 7 shows an illustrative example of a process 700 for determining shipping dates for fulfillment centers of a shipping entity based on shipment transit times from the fulfillment centers to a delivery carrier in accordance with at least one embodiment. The process 700 may be performed by the logistics optimization platform system, which may utilize transit tables from a delivery carrier to determine the shipping times from fulfillment centers of a shipping entity to the delivery carrier to allow for consolidated delivery of shipments to a recipient on a particular date. Further, the process 700 may be performed in an environment wherein items specified in a recipient request obtained by the shipping entity may be located in different fulfillment centers, whereby each fulfillment center may be located in a different geographic region. Further, the process 700 may be performed independent of interactions of other shipping entities with the logistics optimization platform system or delivery carrier. Thus, the process 700 may be performed for a single shipping entity that may split shipments destined for a recipient among any number of fulfillment centers of the shipping entity.

At step 702, the logistics optimization platform system receives, from a shipping entity or other point of sale, sales and delivery orders corresponding to a particular recipient. The recipient requests for a particular recipient may include an invoice that specifies the items ordered by the recipient, the amount paid by the recipient for the items, the payment information of the recipient (e.g., credit card numbers, etc.), a delivery date or range provided to the recipient by the shipping entity, and the like. The delivery orders for a particular recipient may include the individual orders that are to be provided to the one or more fulfillment centers of the shipping entity for delivery of a portion of the recipient request to a delivery carrier for delivery to a location designated by the recipient. For instance, a portion of a recipient request may be fulfilled by one fulfillment center while another portion of the recipient request may be fulfilled by a different fulfillment center.

The fulfillment centers of the shipping entity may be located in different geographic locations. For instance, each fulfillment center may be assigned to maintain and deliver certain items or classes of items on behalf of the shipping entity. Alternatively, a fulfillment center may maintain certain items or classes of items that are subject to greater demand within a particular geographic region serviced by the fulfillment center. Fulfillment centers may further be located near delivery carrier hubs, through which shipments are transited to local delivery carrier locations for delivery to recipients. Fulfillment centers may also be located at or near facilities that manufacture or otherwise import the items sold by the shipping entity and distributed to its recipients. Thus, a set of items ordered by a recipient may be maintained in different fulfillment centers and in different geographic regions.

In response to receiving the sales and delivery orders corresponding to the recipient from the shipping entity, the logistics optimization platform system, at step 704, obtains transit tables for shipments through the delivery carrier to a local delivery carrier facility or distribution center that is to deliver the shipments to the address specified by the recipient in its recipient request. To obtain these transit tables, the logistics optimization platform system may transmit a request to the delivery carrier to retrieve the transit tables specific to the geographic region that includes the delivery address provided by the recipient. In this request, the logistics optimization platform system may provide the address specified by the recipient in its recipient request. Alternatively, the logistics optimization platform system may provide information corresponding to this address (e.g., a zip code, a local delivery carrier location at or near the address provided by the recipient, etc.). In some instances, the logistics optimization platform system may access a system or other platform provided by the delivery carrier to obtain the transit tables. In an embodiment, the logistics optimization platform system maintains the transit tables provided by the delivery carrier and, thus, may refer to these transit tables locally. These transit tables may be updated periodically or in response to a triggering event (e.g., service impacts to the delivery carrier resulting from an event, etc.).

The transit tables provided by the delivery carrier or otherwise maintained by the logistics optimization platform system may indicate the transit times for shipments from different locations to each of the local delivery carrier locations (e.g., distribution centers) from which deliveries may be made within a particular geographic area. For instance, the transit tables may indicate the transit time for a shipment from one particular zip code to another zip code or to a delivery carrier distribution center that services this other zip code. In an embodiment, the logistics optimization platform system evaluates the transit tables to determine, for each fulfillment center that is to fulfill the recipient request by shipping the various items in the recipient request to a local delivery carrier location for delivery to the recipient, the transit time for a shipment from the fulfillment center to the local delivery carrier location. As noted above, the fulfillment centers of the shipping entity may be located in different geographic locations. Thus, the transit times for these fulfillment centers to the local delivery carrier location may differ.

At step 706, the logistics optimization platform system may identify the delivery times for shipments from the fulfillment centers to the delivery carrier location at the recipient destination (e.g., a distribution center that services the geographic region that includes the recipient destination). As noted above, the logistics optimization platform system may use the obtained transit tables to identify the transit times for shipments from each of the fulfillment centers to the local delivery carrier location that is to complete delivery of these shipments to the address specified by the recipient in its recipient request. Further, these transit times may differ. For instance, the transit time for a shipment from one fulfillment center to the local delivery carrier location may be longer or shorter compared to the transit time for another shipment from another fulfillment center to the local delivery carrier location.

At step 708, the logistics optimization platform system determines the shipping date for each of the fulfillment centers that are to fulfill the recipient request based on the identified transit times. For instance, the logistics optimization platform system may calculate, based on the identified transit times and the delivery date provided by the shipping entity to the recipient, a date for each fulfillment center at which the fulfillment center is to initiate transit of a shipment in order for all shipments associated with the recipient request to arrive at the local delivery carrier location for consolidation and delivery to the recipient at the specified delivery date. For example, if the transit time for a first fulfillment center is longer than that for a second fulfillment center, the logistics optimization platform system may determine an earlier ship date for the first fulfillment center in order to ensure that the shipments from these fulfillment centers arrive at the local delivery carrier location concurrently (e.g., at a time or within a time period that allows for consolidation of shipments for performance of a single delivery to a recipient). Thus, the shipping dates for the fulfillment centers may differ.

In an embodiment, the logistics optimization platform system can obtain additional information that may be used to determine the shipping dates. For instance, the logistics optimization platform system may obtain service bulletins or other information from the delivery carrier that may indicate variances to the transit times provided in the transit tables. As an example, in response to a natural disaster that impacts a transit route and/or one or more delivery carrier hubs and distribution centers, the delivery carrier may provide a service bulletin that details the estimated delays or lag in the transit times specified in the transit tables. In an embodiment, the logistics optimization platform system can use machine learning and the transit tables to identify a shipping date for each fulfillment center. For instance, a machine learning model may utilize the transit tables and one or more shipping metrics (e.g., actual transit times from fulfillment centers to different local distribution center locations from previous orders, statistics denoting variances between estimated and actual transit times, statistics denoting performance of each fulfillment center, etc.) as input to generate a shipping date for each fulfillment center.

At step 710, the logistics optimization platform system may provide the delivery orders to the fulfillment centers, along with the determined shipping dates for delivery of the shipments associated with the recipient request to the local delivery carrier location for delivery to the recipient. This may cause each of the fulfillment centers to prepare the various items in the recipient request for shipment to the local delivery carrier location on the designated shipment date. In an embodiment, instead of providing the shipping dates for delivery of the shipments to the delivery carrier, the logistics optimization platform system can provide a delivery order to a fulfillment center on a date that allows the fulfillment center to initiate transit of the shipment to the local delivery carrier location on the shipping date determined by the logistics optimization platform system. For instance, based on a set of performance metrics for a fulfillment center, the logistics optimization platform system may determine the amount of time required by the fulfillment center to prepare and initiate transit of a shipment. Based on this determined amount of time and the identified shipping date, the logistics optimization platform system may identify a date at which the delivery order may be provided to the fulfillment center. Thus, the delivery orders may also be provided to the fulfillment centers at different times.

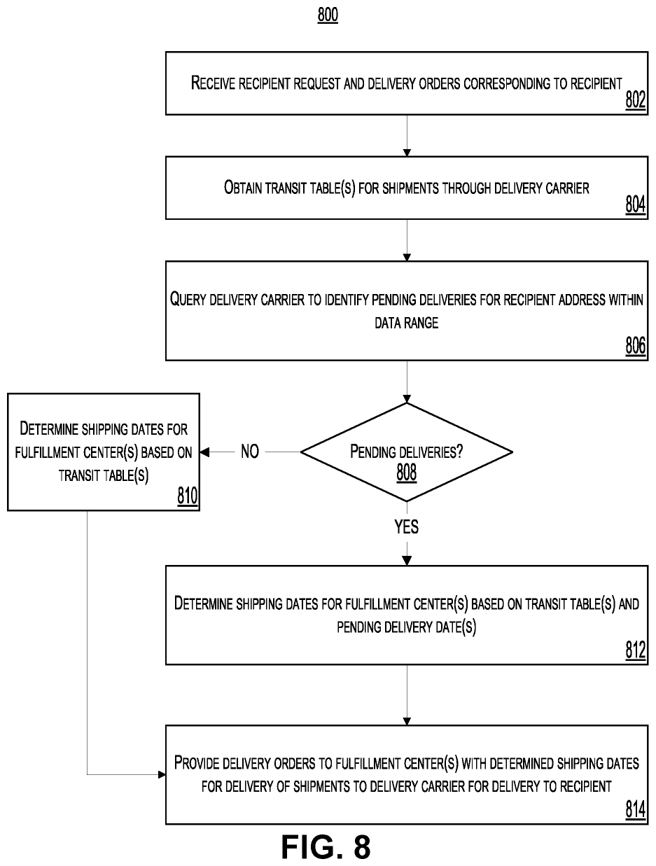

FIG. 8 shows an illustrative example of a process 800 for determining shipping dates for fulfillment centers of a shipping entity based on shipment transit times of the fulfillment centers and pending deliveries from other shipping entities in accordance with at least one embodiment.

The process 800 may be performed by the logistics optimization platform system, which may utilize transit tables from a delivery carrier to determine the shipping times from fulfillment centers of a shipping entity to the delivery carrier for delivery of shipments to a recipient. Further, the process 800 may be performed in an environment wherein shipments from multiple shipping entities can be consolidated at the delivery carrier to allow for consolidated delivery of these shipments to a recipient on a particular date as determined by the logistics optimization platform system. Thus, as opposed to the process 700 described above, whereby split shipments from a particular recipient order with a shipping entity are consolidated, the process 800 is performed in environments wherein shipments from myriad shipping entities utilizing the logistics optimization platform system destined for a particular recipient address or other delivery location can be consolidated for delivery within a particular delivery timeframe.

At step 802, the logistics optimization platform system receives, from a shipping entity or other point of sale, sales and delivery orders corresponding to a particular recipient. The recipient requests for a particular recipient may include an invoice that specifies the items ordered by the recipient, the amount paid by the recipient for the items, the payment information of the recipient (e.g., credit card numbers, etc.), a delivery date or range provided to the recipient by the shipping entity, and the like. The delivery orders for a particular recipient may include the individual orders that are to be provided to the one or more fulfillment centers of the shipping entity for delivery of a portion of the recipient request to a delivery carrier for delivery to a location designated by the recipient when placing its recipient request to the shipping entity. For instance, a portion of a recipient request may be fulfilled by one fulfillment center while another portion of the recipient request may be fulfilled by a different fulfillment center. These fulfillment centers may be located in different geographic locations. For instance, fulfillment centers may each be assigned to maintain and deliver certain items or classes of items on behalf of the shipping entity. Alternatively, a fulfillment center may maintain certain items or classes of items that are subject to greater demand within a particular geographic region serviced by the fulfillment center. Thus, a set of items ordered by a recipient may be maintained in different fulfillment centers and in different geographic regions.

At step 804, the logistics optimization platform system obtains one or more transit tables for shipments through the delivery carrier. For instance, the logistics optimization platform system may transmit a request to the delivery carrier to obtain the one or more transit tables of a delivery carrier location to which the items associated with the recipient request may be delivered for consolidation in anticipation of delivery to the recipient. In its request, the logistics optimization platform system may provide the address to which the items are to be delivered, as well as any recipient preferences for delivery (e.g., preferred delivery date(s), etc.), and other recipient information that may be used to identify any pending deliveries to the same address from one or more other shipping entities.

At step 806, the logistics optimization platform system queries the delivery carrier to identify any pending deliveries for the recipient at the designated address within the preferred delivery dates, or ranges, specified by the recipient in its recipient request. As noted above, the logistics optimization platform system may transmit, to the delivery carrier, the address to which the items specified in the recipient request are to be delivered, as well as the preferred delivery dates or ranges of dates for delivery of the items. Using this information, the delivery carrier may identify any other items or deliveries that are to be made to the same address specified by the logistics optimization platform system within the preferred delivery dates or ranges of dates specified by the recipient in its recipient request through the shipping entity. For instance, if the delivery carrier determines that one or more deliveries are to be made to the indicated address at a preferred delivery date or within a particular date range specified by the recipient, the delivery carrier may indicate, in its response to the shipping entity, that other deliveries are scheduled to be made at the address and on a data corresponding to either the preferred date specified by the recipient or within the date range specified by the recipient. Alternatively, if the delivery carrier determines that no deliveries are to be made to the specified address on the preferred date or within the specified date range, the delivery carrier may indicate that no other deliveries are scheduled for the specified address on the preferred date or within the specified date range.

Based on the response from the delivery carrier, the logistics optimization platform system determines, at step 808, whether there are any pending deliveries from other shipping entities to the recipient's specified address and scheduled for delivery on the preferred date or within the date range specified by the recipient in its recipient request. If the logistics optimization platform system determines that there are no other pending deliveries from other shipping entities scheduled to made to the recipient's specified address on the preferred date or within the date range specified by the recipient, the logistics optimization platform system, at step 810, determines the shipping dates for the one or more fulfillment centers based on the obtained transit tables from the delivery carrier. For instance, using the one or more transit tables, the logistics optimization platform system may determine the amount of time required to ship one or more items from a particular fulfillment center to the delivery carrier. Based on this amount of time, the logistics optimization platform system may determine the date at which the fulfillment center may be required to ship the one or more items to the delivery carrier in order for delivery of the one or more items to be made to the address specified by the recipient on the preferred date or within the data range specified by the recipient. The logistics optimization platform system may perform this operation for each of the identified fulfillment centers that include the items specified in the recipient request. Thus, while each of the identified fulfillment centers may be tasked with shipping their assigned items on different dates to the delivery carrier, based on the transit tables, these items may arrive at the delivery carrier on the same date in order to allow the delivery carrier to consolidate the items from the various fulfillment centers and delivery the consolidated items to the recipient at the indicated address.

In an embodiment, if the logistics optimization platform system determines that there are no other pending deliveries from other shipping entities scheduled to be made to the recipient's specified address, the logistics optimization platform system monitors the delivery carrier for a period of time to determine whether new pending deliveries have been obtained for the recipient's specified address. If new pending deliveries are identified, the logistics optimization platform system obtains the delivery dates for the pending deliveries and determines whether the recipient request of the recipient can be consolidated with these pending deliveries to allow for consolidated delivery of the recipient's items at a particular date. If so, the logistics optimization platform system may set this particular date for delivery and use the one or more transit tables to identify the shipping date for each of the one or more fulfillment centers that are used to fulfill the recipient request to ensure that the items in the recipient request arrive at the delivery carrier for consolidated delivery with the pending deliveries to the recipient.

If the logistics optimization platform system determines that there are pending deliveries that are to be made for other shipping entities to the address specified by the recipient, the logistics optimization platform system, at step 812, determines the shipping dates for the one or more fulfillment centers based on the obtained transit tables and the pending delivery dates for other shipping entities obtained from the delivery carrier. For instance, if the logistics optimization platform system determines that one or more pending deliveries are to be made to the address specified by the recipient on a particular date, the logistics optimization platform system may select this particular date as the date in which the shipments from the one or more fulfillment centers are to arrive at the delivery carrier in order to allow the delivery carrier to consolidate these shipments with the pending deliveries. In an embodiment, if the pending deliveries are scheduled within a particular date range that coincides with a date range provided by the recipient, the logistics optimization platform system can coordinate with the delivery carrier to select a particular date for completing the pending deliveries and the delivering the one or more items in the recipient request in a consolidated delivery to the recipient at the specified address.

At step 814, the logistics optimization platform system provides the delivery orders to the one or more fulfillment centers, along with the identified shipping date for each of the one or more fulfillment centers, for delivery of the shipments corresponding to the recipient request to the delivery carrier for consolidated delivery to the recipient. As noted above, the logistics optimization platform system may utilize the one or more transit tables obtained from the delivery carrier to determine the transit time for shipments from each fulfillment center to the delivery carrier location from which the consolidated delivery is to be made. Using these transit times and the delivery date to the recipient, the logistics optimization platform system may determine a shipping date for each fulfillment center in order to have the recipient's items arrive at the delivery carrier in time for consolidation and delivery to the recipient at the specified delivery date. These shipping dates are provided to the one or more fulfillment centers, which may send the shipments to the delivery carrier at their designated shipping dates.

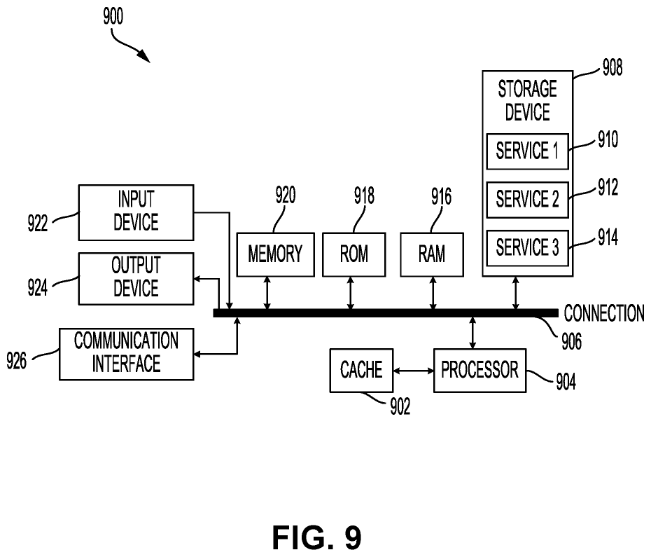

FIG. 9 illustrates a computing system architecture 900 including various components in electrical communication with each other using a connection 906, such as a bus, in accordance with some implementations. Example system architecture 900 includes a processing unit (CPU or processor) 904 and a system connection 906 that couples various system components including the system memory 920, such as ROM 918 and RAM 916, to the processor 904. The system architecture 900 can include a cache 902 of high-speed memory connected directly with, in close proximity to, or integrated as part of the processor 904. The system architecture 900 can copy data from the memory 920 and/or the storage device 908 to the cache 902 for quick access by the processor 904. In this way, the cache can provide a performance boost that avoids processor 904 delays while waiting for data. These and other modules can control or be configured to control the processor 904 to perform various actions.

Other system memory 920 may be available for use as well. The memory 920 can include multiple different types of memory with different performance characteristics. The processor 904 can include any general purpose processor and a hardware or software service, such as service 1 910, service 2 912, and service 3 914 stored in storage device 908, configured to control the processor 904 as well as a special-purpose processor where software instructions are incorporated into the actual processor design. The processor 904 may be a completely self-contained computing system, containing multiple cores or processors, a bus, memory controller, cache, etc. A multi-core processor may be symmetric or asymmetric.

To enable user interaction with the computing system architecture 900, an input device 922 can represent any number of input mechanisms, such as a microphone for speech, a touch-sensitive screen for gesture or graphical input, keyboard, mouse, motion input, speech and so forth. An output device 924 can also be one or more of a number of output mechanisms known to those of skill in the art. In some instances, multimodal systems can enable a user to provide multiple types of input to communicate with the computing system architecture 900. The communications interface 926 can generally govern and manage the user input and system output. There is no restriction on operating on any particular hardware arrangement and therefore the basic features here may easily be substituted for improved hardware or firmware arrangements as they are developed.

Storage device 908 is a non-volatile memory and can be a hard disk or other types of computer readable media which can store data that are accessible by a computer, such as magnetic cassettes, flash memory cards, solid state memory devices, digital versatile disks, cartridges, RAMs 916, ROM 918, and hybrids thereof.

The storage device 908 can include services 910, 912, 914 for controlling the processor 904. Other hardware or software modules are contemplated. The storage device 908 can be connected to the system connection 906. In one aspect, a hardware module that performs a particular function can include the software component stored in a computer-readable medium in connection with the necessary hardware components, such as the processor 904, connection 906, output device 924, and so forth, to carry out the function.

The disclosed system can be performed using a computing system. An example computing system can include a processor (e.g., a central processing unit), memory, non-volatile memory, and an interface device. The memory may store data and/or and one or more code sets, software, scripts, etc. The components of the computer system can be coupled together via a bus or through some other known or convenient device. The processor may be configured to carry out all or part of methods described herein for example by executing code for example stored in memory. One or more of a user device or computer, a provider server or system, or a suspended database update system may include the components of the computing system or variations on such a system.

This disclosure contemplates the computer system taking any suitable physical form, including, but not limited to a Point-of-Sale system (“POS”). As example and not by way of limitation, the computer system may be an embedded computer system, a system-on-chip (SOC), a single-board computer system (SBC) (such as, for example, a computer-on-module (COM) or system-on-module (SOM)), a desktop computer system, a laptop or notebook computer system, an interactive kiosk, a mainframe, a mesh of computer systems, a mobile telephone, a personal digital assistant (PDA), a server, or a combination of two or more of these. Where appropriate, the computer system may include one or more computer systems; be unitary or distributed; span multiple locations; span multiple machines; and/or reside in a cloud, which may include one or more cloud components in one or more networks. Where appropriate, one or more computer systems may perform without substantial spatial or temporal limitation one or more steps of one or more methods described or illustrated herein. As an example and not by way of limitation, one or more computer systems may perform in real time or in batch mode one or more steps of one or more methods described or illustrated herein. One or more computer systems may perform at different times or at different locations one or more steps of one or more methods described or illustrated herein, where appropriate.

The processor may be, for example, be a conventional microprocessor such as an Intel Pentium microprocessor or Motorola power PC microprocessor. One of skill in the relevant art will recognize that the terms “machine-readable (storage) medium” or “computer-readable (storage) medium” include any type of device that is accessible by the processor.

The memory can be coupled to the processor by, for example, a bus. The memory can include, by way of example but not limitation, random access memory (RAM), such as dynamic RAM (DRAM) and static RAM (SRAM). The memory can be local, remote, or distributed.

The bus can also couples the processor to the non-volatile memory and drive unit. The non-volatile memory is often a magnetic floppy or hard disk, a magnetic-optical disk, an optical disk, a read-only memory (ROM), such as a CD-ROM, EPROM, or EEPROM, a magnetic or optical card, or another form of storage for large amounts of data. Some of this data is often written, by a direct memory access process, into memory during execution of software in the computer. The non-volatile storage can be local, remote, or distributed. The non-volatile memory is optional because systems can be created with all applicable data available in memory. A typical computer system will usually include at least a processor, memory, and a device (e.g., a bus) coupling the memory to the processor.

Software can be stored in the non-volatile memory and/or the drive unit. Indeed, for large programs, it may not even be possible to store the entire program in the memory. Nevertheless, it should be understood that for software to run, if necessary, it is moved to a computer readable location appropriate for processing, and for illustrative purposes, that location is referred to as the memory herein. Even when software is moved to the memory for execution, the processor can make use of hardware registers to store values associated with the software, and local cache that, ideally, serves to speed up execution. As used herein, a software program is assumed to be stored at any known or convenient location (from non-volatile storage to hardware registers), when the software program is referred to as “implemented in a computer-readable medium.” A processor is considered to be “configured to execute a program” when at least one value associated with the program is stored in a register readable by the processor.

The bus can also couples the processor to the network interface device. The interface can include one or more of a modem or network interface. It will be appreciated that a modem or network interface can be considered to be part of the computer system. The interface can include an analog modem, Integrated Services Digital network (ISDN0 modem, cable modem, token ring interface, satellite transmission interface (e.g., “direct PC”), or other interfaces for coupling a computer system to other computer systems. The interface can include one or more input and/or output (I/O) devices. The I/O devices can include, by way of example but not limitation, a keyboard, a mouse or other pointing device, disk drives, printers, a scanner, and other input and/or output devices, including a display device. The display device can include, by way of example but not limitation, a cathode ray tube (CRT), liquid crystal display (LCD), or some other applicable known or convenient display device.

In operation, the computer system can be controlled by operating system software that includes a file management system, such as a disk operating system. One example of operating system software with associated file management system software is the family of operating systems known as Windows® from Microsoft Corporation of Redmond, Wash., and their associated file management systems. Another example of operating system software with its associated file management system software is the Linux™ operating system and its associated file management system. The file management system can be stored in the non-volatile memory and/or drive unit and can cause the processor to execute the various acts required by the operating system to input and output data and to store data in the memory, including storing files on the non-volatile memory and/or drive unit.

Some portions of the detailed description may be presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or “generating” or the like, refer to the action and processes of a computer system, or similar electronic computing device, that manipulates and transforms data represented as physical (electronic) quantities within registers and memories of the computer system into other data similarly represented as physical quantities within the computer system memories or registers or other such information storage, transmission or display devices.

The algorithms and displays presented herein are not inherently related to any particular computer or other apparatus. Various general purpose systems may be used with programs in accordance with the teachings herein, or it may prove convenient to construct more specialized apparatus to perform the methods of some examples. The required structure for a variety of these systems will appear from the description below. In addition, the techniques are not described with reference to any particular programming language, and various examples may thus be implemented using a variety of programming languages.

In various implementations, the system operates as a standalone device or may be connected (e.g., networked) to other systems. In a networked deployment, the system may operate in the capacity of a server or a client system in a client-server network environment, or as a peer system in a peer-to-peer (or distributed) network environment.

The system may be a server computer, a client computer, a personal computer (PC), a tablet PC, a laptop computer, a set-top box (STB), a personal digital assistant (PDA), a cellular telephone, an iPhone, a Blackberry, a processor, a telephone, a web appliance, a network router, switch or bridge, or any system capable of executing a set of instructions (sequential or otherwise) that specify actions to be taken by that system.

While the machine-readable medium or machine-readable storage medium is shown, by way of example, to be a single medium, the term “machine-readable medium” and “machine-readable storage medium” should be taken to include a single medium or multiple media (e.g., a centralized or distributed database, and/or associated caches and servers) that store the one or more sets of instructions. The term “machine-readable medium” and “machine-readable storage medium” shall also be taken to include any medium that is capable of storing, encoding, or carrying a set of instructions for execution by the system and that cause the system to perform any one or more of the methodologies or modules of disclosed herein.

In general, the routines executed to implement the implementations of the disclosure, may be implemented as part of an operating system or a specific application, component, program, object, module or sequence of instructions referred to as “computer programs.” The computer programs typically comprise one or more instructions set at various times in various memory and storage devices in a computer, and that, when read and executed by one or more processing units or processors in a computer, cause the computer to perform operations to execute elements involving the various aspects of the disclosure.

Moreover, while examples have been described in the context of fully functioning computers and computer systems, those skilled in the art will appreciate that the various examples are capable of being distributed as a program object in a variety of forms, and that the disclosure applies equally regardless of the particular type of machine or computer-readable media used to actually effect the distribution.

Further examples of machine-readable storage media, machine-readable media, or computer-readable (storage) media include but are not limited to recordable type media such as volatile and non-volatile memory devices, floppy and other removable disks, hard disk drives, optical disks (e.g., Compact Disk Read-Only Memory (CD ROMS), Digital Versatile Disks, (DVDs), etc.), among others, and transmission type media such as digital and analog communication links.

In some circumstances, operation of a memory device, such as a change in state from a binary one to a binary zero or vice-versa, for example, may comprise a transformation, such as a physical transformation. With particular types of memory devices, such a physical transformation may comprise a physical transformation of an article to a different state or thing. For example, but without limitation, for some types of memory devices, a change in state may involve an accumulation and storage of charge or a release of stored charge. Likewise, in other memory devices, a change of state may comprise a physical change or transformation in magnetic orientation or a physical change or transformation in molecular structure, such as from crystalline to amorphous or vice versa. The foregoing is not intended to be an exhaustive list of all examples in which a change in state for a binary one to a binary zero or vice-versa in a memory device may comprise a transformation, such as a physical transformation. Rather, the foregoing is intended as illustrative examples.

A storage medium typically may be non-transitory or comprise a non-transitory device. In this context, a non-transitory storage medium may include a device that is tangible, meaning that the device has a concrete physical form, although the device may change its physical state. Thus, for example, non-transitory refers to a device remaining tangible despite this change in state.

The above description and drawings are illustrative and are not to be construed as limiting the subject matter to the precise forms disclosed. Persons skilled in the relevant art can appreciate that many modifications and variations are possible in light of the above disclosure. Numerous specific details are described to provide a thorough understanding of the disclosure. However, in certain instances, well-known or conventional details are not described in order to avoid obscuring the description.

As used herein, the terms “connected,” “coupled,” or any variant thereof when applying to modules of a system, means any connection or coupling, either direct or indirect, between two or more elements; the coupling of connection between the elements can be physical, logical, or any combination thereof. Additionally, the words “herein,” “above,” “below,” and words of similar import, when used in this application, shall refer to this application as a whole and not to any particular portions of this application. Where the context permits, words in the above Detailed Description using the singular or plural number may also include the plural or singular number respectively. The word “or,” in reference to a list of two or more items, covers all of the following interpretations of the word: any of the items in the list, all of the items in the list, or any combination of the items in the list.

Those of skill in the art will appreciate that the disclosed subject matter may be embodied in other forms and manners not shown below. It is understood that the use of relational terms, if any, such as first, second, top and bottom, and the like are used solely for distinguishing one entity or action from another, without necessarily requiring or implying any such actual relationship or order between such entities or actions.

While processes or blocks are presented in a given order, alternative implementations may perform routines having steps, or employ systems having blocks, in a different order, and some processes or blocks may be deleted, moved, added, subdivided, substituted, combined, and/or modified to provide alternative or sub combinations. Each of these processes or blocks may be implemented in a variety of different ways. Also, while processes or blocks are at times shown as being performed in series, these processes or blocks may instead be performed in parallel, or may be performed at different times. Further any specific numbers noted herein are only examples: alternative implementations may employ differing values or ranges.

The teachings of the disclosure provided herein can be applied to other systems, not necessarily the system described above. The elements and acts of the various examples described above can be combined to provide further examples.

Any patents and applications and other references noted above, including any that may be listed in accompanying filing papers, are incorporated herein by reference. Aspects of the disclosure can be modified, if necessary, to employ the systems, functions, and concepts of the various references described above to provide yet further examples of the disclosure.

These and other changes can be made to the disclosure in light of the above Detailed Description. While the above description describes certain examples, and describes the best mode contemplated, no matter how detailed the above appears in text, the teachings can be practiced in many ways. Details of the system may vary considerably in its implementation details, while still being encompassed by the subject matter disclosed herein. As noted above, particular terminology used when describing certain features or aspects of the disclosure should not be taken to imply that the terminology is being redefined herein to be restricted to any specific characteristics, features, or aspects of the disclosure with which that terminology is associated. In general, the terms used in the following claims should not be construed to limit the disclosure to the specific implementations disclosed in the specification, unless the above Detailed Description section explicitly defines such terms. Accordingly, the actual scope of the disclosure encompasses not only the disclosed implementations, but also all equivalent ways of practicing or implementing the disclosure under the claims.

While certain aspects of the disclosure are presented below in certain claim forms, the inventors contemplate the various aspects of the disclosure in any number of claim forms. Any claims intended to be treated under 35 U.S.C. § 112(f) will begin with the words “means for”. Accordingly, the applicant reserves the right to add additional claims after filing the application to pursue such additional claim forms for other aspects of the disclosure.

The terms used in this specification generally have their ordinary meanings in the art, within the context of the disclosure, and in the specific context where each term is used. Certain terms that are used to describe the disclosure are discussed above, or elsewhere in the specification, to provide additional guidance to the practitioner regarding the description of the disclosure. For convenience, certain terms may be highlighted, for example using capitalization, italics, and/or quotation marks. The use of highlighting has no influence on the scope and meaning of a term; the scope and meaning of a term is the same, in the same context, whether or not it is highlighted. It will be appreciated that same element can be described in more than one way.

Consequently, alternative language and synonyms may be used for any one or more of the terms discussed herein, nor is any special significance to be placed upon whether or not a term is elaborated or discussed herein. Synonyms for certain terms are provided. A recital of one or more synonyms does not exclude the use of other synonyms. The use of examples anywhere in this specification including examples of any terms discussed herein is illustrative only, and is not intended to further limit the scope and meaning of the disclosure or of any exemplified term. Likewise, the disclosure is not limited to various examples given in this specification.

Without intent to further limit the scope of the disclosure, examples of instruments, apparatus, methods and their related results according to the examples of the present disclosure are given below. Note that titles or subtitles may be used in the examples for convenience of a reader, which in no way should limit the scope of the disclosure. Unless otherwise defined, all technical and scientific terms used herein have the same meaning as commonly understood by one of ordinary skill in the art to which this disclosure pertains. In the case of conflict, the present document, including definitions will control.

Some portions of this description describe examples in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In some examples, a software module is implemented with a computer program object comprising a computer-readable medium containing computer program code, which can be executed by a computer processor for performing any or all of the steps, operations, or processes described.

Examples may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Examples may also relate to an object that is produced by a computing process described herein. Such an object may comprise information resulting from a computing process, where the information is stored on a non-transitory, tangible computer readable storage medium and may include any implementation of a computer program object or other data combination described herein.

The language used in the specification has been principally selected for readability and instructional purposes, and it may not have been selected to delineate or circumscribe the subject matter. It is therefore intended that the scope of this disclosure be limited not by this detailed description, but rather by any claims that issue on an application based hereon. Accordingly, the disclosure of the examples is intended to be illustrative, but not limiting, of the scope of the subject matter, which is set forth in the following claims.

Specific details were given in the preceding description to provide a thorough understanding of various implementations of systems and components for a contextual connection system. It will be understood by one of ordinary skill in the art, however, that the implementations described above may be practiced without these specific details. For example, circuits, systems, networks, processes, and other components may be shown as components in block diagram form in order not to obscure the embodiments in unnecessary detail. In other instances, well-known circuits, processes, algorithms, structures, and techniques may be shown without unnecessary detail in order to avoid obscuring the embodiments.

It is also noted that individual implementations may be described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but could have additional steps not included in a figure. A process may correspond to a method, a function, a procedure, a subroutine, a subprogram, etc. When a process corresponds to a function, its termination can correspond to a return of the function to the calling function or the main function.

Client devices, network devices, and other devices can be computing systems that include one or more integrated circuits, input devices, output devices, data storage devices, and/or network interfaces, among other things. The integrated circuits can include, for example, one or more processors, volatile memory, and/or non-volatile memory, among other things. The input devices can include, for example, a keyboard, a mouse, a key pad, a touch interface, a microphone, a camera, and/or other types of input devices. The output devices can include, for example, a display screen, a speaker, a haptic feedback system, a printer, and/or other types of output devices. A data storage device, such as a hard drive or flash memory, can enable the computing device to temporarily or permanently store data. A network interface, such as a wireless or wired interface, can enable the computing device to communicate with a network. Examples of computing devices include desktop computers, laptop computers, server computers, hand-held computers, tablets, smart phones, personal digital assistants, digital home assistants, as well as machines and apparatuses in which a computing device has been incorporated.

The term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), flash memory, memory or memory devices. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, or the like.

The various examples discussed above may further be implemented by hardware, software, firmware, middleware, microcode, hardware description languages, or any combination thereof. When implemented in software, firmware, middleware or microcode, the program code or code segments to perform the necessary tasks (e.g., a computer-program product) may be stored in a computer-readable or machine-readable storage medium (e.g., a medium for storing program code or code segments). A processor(s), implemented in an integrated circuit, may perform the necessary tasks.

Where components are described as being “configured to” perform certain operations, such configuration can be accomplished, for example, by designing electronic circuits or other hardware to perform the operation, by programming programmable electronic circuits (e.g., microprocessors, or other suitable electronic circuits) to perform the operation, or any combination thereof.

The various illustrative logical blocks, modules, circuits, and algorithm steps described in connection with the implementations disclosed herein may be implemented as electronic hardware, computer software, firmware, or combinations thereof. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium comprising program code including instructions that, when executed, performs one or more of the methods described above. The computer-readable data storage medium may form part of a computer program product, which may include packaging materials. The computer-readable medium may comprise memory or data storage media, such as random access memory (RAM) such as synchronous dynamic random access memory (SDRAM), read-only memory (ROM), non-volatile random access memory (NVRAM), electrically erasable programmable read-only memory (EEPROM), FLASH memory, magnetic or optical data storage media, and the like. The techniques additionally, or alternatively, may be realized at least in part by a computer-readable communication medium that carries or communicates program code in the form of instructions or data structures and that can be accessed, read, and/or executed by a computer, such as propagated signals or waves.

The program code may be executed by a processor, which may include one or more processors, such as one or more digital signal processors (DSPs), general purpose microprocessors, an application specific integrated circuits (ASICs), field programmable logic arrays (FPGAs), or other equivalent integrated or discrete logic circuitry. Such a processor may be configured to perform any of the techniques described in this disclosure. A general purpose processor may be a microprocessor; but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein. In addition, in some aspects, the functionality described herein may be provided within dedicated software modules or hardware modules configured for implementing a suspended database update system.

The foregoing detailed description of the technology has been presented for purposes of illustration and description. It is not intended to be exhaustive or to limit the technology to the precise form disclosed. Many modifications and variations are possible in light of the above teaching. The described embodiments were chosen in order to best explain the principles of the technology, its practical application, and to enable others skilled in the art to utilize the technology in various embodiments and with various modifications as are suited to the particular use contemplated. It is intended that the scope of the technology be defined by the claim.

What is claimed is:

1. A computer-implemented method comprising:
receiving, by a computer system, a request to obtain a set of items and a set of delivery orders, wherein the request indicates an address of a recipient for delivery of the set of items, and wherein the set of delivery orders correspond to a set of fulfillment centers tasked with fulfilling the request;
obtaining, by the computer system, a set of transit tables of a delivery carrier, wherein the set of transit tables specify transit times from the set of fulfillment centers to a distribution center of the delivery carrier;
determining, by the computer system, shipping dates for the set of fulfillment centers, wherein the shipping dates are determined based on the transit times, and wherein the shipping dates correspond to a date in which the set of items are to arrive at the distribution center; and
providing, by the computer system, the set of delivery orders and the shipping dates to cause the set of fulfillment centers to fulfill the request in accordance with the shipping dates to cause the delivery carrier to consolidate the set of items at the distribution center for the delivery to the recipient.

2. The computer-implemented method of claim 1, further comprising:
identifying, by the computer system, one or more pending deliveries to be performed by the delivery carrier to the address of the recipient;
identifying, by the computer system, a set of dates corresponding to the one or more pending deliveries;
determining, by the computer system, whether the request can be consolidated with the one or more pending deliveries based on the set of dates and delivery date preferences defined in the request; and
selecting the date in which the set of items are scheduled to arrive at the distribution center based on the delivery date preferences and the set of dates corresponding to the one or more pending deliveries.

3. The computer-implemented method of claim 1, further comprising using, by the computer system, a machine learning algorithm to determine the shipping dates, wherein the machine learning algorithm uses the set of transit tables and performance metrics of the set of fulfillment centers as input to produce the shipping dates.

4. The computer-implemented method of claim 1, further comprising:
identifying, by the computer system, one or more pending deliveries to be performed by the delivery carrier at locations other than the address of the recipient;
identifying, by the computer system, a set of dates corresponding to the one or more pending deliveries; and
providing, by the computer system, one or more delivery options for delivery of the set of items to the locations within the set of dates.

5. The computer-implemented method of claim 1, wherein the request and the set of delivery orders associated with the recipient are obtained by the computer system from a representational state transfer (REST) application programming interface (API) call.

6. The computer-implemented method of claim 1, wherein:
the request further specifies a preferred date for the delivery; and
the method further comprises determining, by the computer system and based on the transit times from the transit tables, whether the delivery can be completed on the preferred date.

7. The computer-implemented method of claim 1, wherein the delivery orders are provided to the set of fulfillment centers in accordance with the shipping dates.

8. A system, comprising:
one or more processors; and
memory storing thereon instructions that, as a result of being executed by the one or more processors, cause the system to:
receive a request to obtain a set of items and a set of delivery orders, wherein the request indicates an address of a recipient for delivery of the set of items, and wherein the set of delivery orders correspond to a set of fulfillment centers tasked with fulfilling the request;
obtain a set of transit tables of a delivery carrier, wherein the set of transit tables specify transit times from the set of fulfillment centers to a distribution center of the delivery carrier;
determine shipping dates for the set of fulfillment centers, wherein the shipping dates are determined based on the transit times, and wherein the shipping dates correspond to a date in which the set of items are to arrive at the distribution center; and
provide the set of delivery orders and the shipping dates to cause the set of fulfillment centers to fulfill the request in accordance with the shipping dates to cause the delivery carrier to consolidate the set of items at the distribution center for the delivery to the recipient.

9. The system of claim 8, wherein the instructions further cause the system to:
identify one or more pending deliveries to be performed by the delivery carrier to the address of the recipient;
identify a set of dates corresponding to the one or more pending deliveries;
determine whether the request can be consolidated with the one or more pending deliveries based on the set of dates and delivery date preferences defined in the request; and
select the date in which the set of items are scheduled to arrive at the distribution center based on the delivery date preferences and the set of dates corresponding to the one or more pending deliveries.

10. The system of claim 8, wherein the instructions further cause the system to use a machine learning algorithm to determine the shipping dates, wherein the machine learning algorithm uses the set of transit tables and performance metrics of the set of fulfillment centers as input to produce the shipping dates.

11. The system of claim 8, wherein the instructions further cause the system to:
identify one or more pending deliveries to be performed by the delivery carrier at locations other than the address of the recipient;
identify a set of dates corresponding to the one or more pending deliveries; and
provide one or more delivery options for delivery of the set of items to the locations within the set of dates.

12. The system of claim 8, wherein the request and the set of delivery orders associated with the recipient are obtained by the computer system from a representational state transfer (REST) application programming interface (API) call.

13. The system of claim 8, wherein:
the request further specifies a preferred date for the delivery; and
the instructions further cause the system to determine, based on the transit times from the transit tables, whether the delivery can be completed on the preferred date.

14. The system of claim 8, wherein the delivery orders are provided to the set of fulfillment centers in accordance with the shipping dates.

15. A non-transitory computer-readable storage medium having stored thereon instructions that, when executed by one or more processors, cause the one or more processors to:
receive a request to obtain a set of items and a set of delivery orders, wherein the request indicates an address of a recipient for delivery of the set of items, and wherein the set of delivery orders correspond to a set of fulfillment centers tasked with fulfilling the request;
obtain a set of transit tables of a delivery carrier, wherein the set of transit tables specify transit times from the set of fulfillment centers to a distribution center of the delivery carrier;
determine shipping dates for the set of fulfillment centers, wherein the shipping dates are determined based on the transit times, and wherein the shipping dates correspond to a date in which the set of items are to arrive at the distribution center; and
provide the set of delivery orders and the shipping dates to cause the set of fulfillment centers to fulfill the request in accordance with the shipping dates to cause the delivery carrier to consolidate the set of items at the distribution center for the delivery to the recipient.

16. The non-transitory computer-readable storage medium of claim 15, wherein the executable instructions further cause the one or more processors to:
identify one or more pending deliveries to be performed by the delivery carrier to the address of the recipient;
identify a set of dates corresponding to the one or more pending deliveries;
determine whether the request can be consolidated with the one or more pending deliveries based on the set of dates and delivery date preferences defined in the request; and
select the date in which the set of items are scheduled to arrive at the distribution center based on the delivery date preferences and the set of dates corresponding to the one or more pending deliveries.

17. The non-transitory computer-readable storage medium of claim 15, wherein the executable instructions further cause the one or more processors to determine the shipping dates, wherein the machine learning algorithm uses the set of transit tables and performance metrics of the set of fulfillment centers as input to produce the shipping dates.

18. The non-transitory computer-readable storage medium of claim 15, wherein the executable instructions further cause the one or more processors to:
identify one or more pending deliveries to be performed by the delivery carrier at locations other than the address of the recipient;
identify a set of dates corresponding to the one or more pending deliveries; and
provide one or more delivery options for delivery of the set of items to the locations within the set of dates.

19. The non-transitory computer-readable storage medium of claim 15, wherein the request and the set of delivery orders associated with the recipient are obtained by the computer system from a representational state transfer (REST) application programming interface (API) call.

20. The non-transitory computer-readable storage medium of claim 15, wherein:
the request further specifies a preferred date for the delivery; and
the executable instructions further cause the one or more processors to determine, based on the transit times from the transit tables, whether the delivery can be completed on the preferred date.

21. The non-transitory computer-readable storage medium of claim 15, wherein the delivery orders are provided to the set of fulfillment centers in accordance with the shipping dates.
